(19) United States
(12) Patent Application Publication
(10) Pub. No.: US 2014/0141224 A1
(43) Pub. Date: May 22, 2014

(54) FABRICATION OF CARBON FOAMS THROUGH SOLUTION PROCESSING IN SUPERACIDS

(71) Applicants: Matteo Pasquali, Houston, TX (US); Tien Yi Theresa Hsu Whiting, Doylestown, OH (US); Francesca Mirri, Houston, TX (US); Bryan Thomas Whiting, Doylestown, OH (US)

(72) Inventors: Matteo Pasquali, Houston, TX (US); Tien Yi Theresa Hsu Whiting, Doylestown, OH (US); Francesca Mirri, Houston, TX (US); Bryan Thomas Whiting, Doylestown, OH (US)

(73) Assignee: William Marsh Rice University, Houston, TX (US)

(21) Appl. No.: 14/075,344

(22) Filed: Nov. 8, 2013

Related U.S. Application Data
(60) Provisional application No. 61/723,947, filed on Nov. 8, 2012.

(51) Int. Cl. C01B 31/08; B05D 3/02; B05D 7/24

(52) U.S. Cl. CPC C01B 31/089; B05D 7/24; B05D 3/0254
USPC 428/219; 423/460; 427/180; 427/128; 427/132; 427/443.2; 427/372.2; 428/312.2

(57) ABSTRACT

In some embodiments, the present disclosure pertains to methods of making carbon foams. In some embodiments, the methods comprise: (a) dissolving a carbon source in a superacid to form a solution; (b) placing the solution in a mold; and (c) coagulating the carbon source in the mold. In some embodiments, the methods of the present disclosure further comprise a step of washing the coagulated carbon source. In some embodiments, the methods of the present disclosure further comprise a step of lyophilizing the coagulated carbon source. In some embodiments, the methods of the present disclosure further comprise a step of drying the coagulated carbon source. In some embodiments, the methods of the present disclosure also include steps of infiltrating the formed carbon foams with nanoparticles or polymers. Further embodiments of the present disclosure pertain to the carbon foams formed by the aforementioned methods.

### CROSS-REFERENCE TO RELATED APPLICATIONS

This application claims priority to U.S. Provisional Patent Application No. 61/723,947, filed on Nov. 8, 2012. The entirety of the aforementioned application is incorporated herein by reference.

### STATEMENT REGARDING FEDERALLY SPONSORED RESEARCH

This invention was made with government support under Air Force Office of Scientific Research Grant No. FA9550-12-1-0035, awarded by the U.S. Department of Defense. The government has certain rights in the invention.

### BACKGROUND

Current methods to make carbon foam structures have various limitations. For instance, current methods yield materials with high densities and non-optimal electrical and thermal conductivities. Therefore, a need exists for more improved methods of making carbon foam structures.

### BRIEF SUMMARY

In some embodiments, the present disclosure pertains to methods of making carbon foams. In some embodiments, the methods comprise: (a) dissolving a carbon source in a superacid to form a solution; (b) placing the solution in a mold; and (c) coagulating the carbon source in the mold. In some embodiments, the methods of the present disclosure further comprise a step of washing the coagulated carbon source. In some embodiments, the methods of the present disclosure further comprise a step of lyophilizing the coagulated carbon source. In some embodiments, the methods of the present disclosure further comprise a step of drying the coagulated carbon source.

In some embodiments, the superacid includes chlorosulfonic acid. In some embodiments, the carbon source includes at least one of graphenes, fullerenes, fluorenes, carbon nanotubes, and combinations thereof. In some embodiments, the carbon source includes carbon nanotubes, such as single-walled carbon nanotubes, short single-walled carbon nanotubes, ultra-short single-walled carbon nanotubes, double-walled carbon nanotubes, multi-walled carbon nanotubes, pristine carbon nanotubes, un-functionalized carbon nanotubes and combinations thereof.

In some embodiments, the solutions of the present disclosure may only consist of superacids and carbon sources. In some embodiments, the solutions of the present disclosure may also include one or more additives. In some embodiments, the additives may be associated with carbon sources during coagulation. In some embodiments, the additives include, without limitation, surfactants, silica particles, polymer particles, metal particles, organic solvents, amine-based solvents, fluorinated organic solvents, hydrophobic organic solvents, and combinations thereof. In some embodiments, the additives may help control the structure of the formed carbon foams during coagulation.

In some embodiments, the methods of the present disclosure occur without the use of surfactants or organic binders. In some embodiments, the methods of the present disclosure occur without the use of sonication. In some embodiments, the methods of the present disclosure occur without the use of chemical vapor deposition.

In some embodiments, the methods of the present disclosure also include a step of infiltrating the formed carbon foams with nanoparticles, such as magnetic nanoparticles. In some embodiments, the methods of the present disclosure also include a step of infiltrating the formed carbon foams with polymers, such as polydimethylsiloxane (PDMS), polyvinyl alcohol (PVA), polyethylene glycol (PEG), poly (epoxides) (epoxy resins), cross-linked polymer hydrogels, and combinations thereof.

Further embodiments of the present disclosure pertain to the carbon foams formed by the methods of the present disclosure. In some embodiments, the formed carbon foams comprise continuous networks of isotropic carbon nanotubes. In some embodiments, the formed carbon foams have surface areas between about 400 m²/g to about 900 m²/g. In some embodiments, the formed carbon foams have electrical conductivities greater than about 10 S/cm. In some embodiments, the formed carbon foams have a Young's modulus between about 1 MPA to about 10,000 MPA at 60% strain.

### BRIEF DESCRIPTION OF THE FIGURES

FIG. 1 provides a general scheme for fabricating carbon foams.

FIG. 2 provides data and illustrations relating to the fabrication of carbon nanotube (CNT) foams. FIG. 2A provides a general procedure for fabricating CNT foams by solution processing in chlorosulfonic acid (CSA). FIG. 2B provides examples of cubic and cylindrical molds used to fabricate foams, made from stainless steel mesh sheets. FIG. 2C provides examples of double-wall carbon nanotube (DWNT) foams in a variety of shapes and sizes, depending on the molds used. FIG. 2D provides scanning electron micrograph (SEM) images of the CNT foams, using both long DWNT (top) and short single-wall carbon nanotubes (SWNT) (bottom) at comparable measured dry foam densities (15-16 mg/cm³). FIG. 2E shows a picture of a dry CNT foam (left panel) and an SEM image of the dry CNT foam (right panel).

FIG. 3 provides additional data relating to fabricated CNT foams. FIG. 3A provides measured densities of as-synthesized CNT foams as a function of initial solution concentration in CSA. FIG. 3B provides compressive modulus of elasticity (sometimes reported as Young's modulus). FIGS. 3C-3D provide specific electrical conductivity (FIG. 3C) and specific thermal conductivity (FIG. 3D) as a function of average foam density. FIG. 3E shows a piece of DWNT foam weighing 9.8±0.1 mg (density ˜15 mg/cm³) that is easily supported by a feather but able to sustain a 10 g metal block that is more than 1000 times its own weight. FIG. 3F shows two pieces of DWNT foams (15 mg/cm³) conduct electricity to power an LED light.

FIG. 4 provides data relating to the properties of polydimethysiloxane (PDMS) infiltrated DWNT foams (PDMS-DWNT composites or CNT-polymer composites). FIGS. 4A-4B provide data relating to the electrical conductivity versus compressive modulus (FIG. 4A), and electrical conductivity versus percent plastic deformation (FIG. 4B) (for the first compression cycle, 60% strain) of different CNT-polymer composites produced through direct infiltration. All composites retain over 50% of the original CNT foam conductivity; yet their mechanical properties can be tuned by the polymer matrix. FIG. 4C provides an LED light installed between 2 pieces of the PDMS-DWNT composite connected to a 9V battery that remains lit while the composite samples are compressed, retaining their conductive properties. FIG. 4D provides recovery time for the shape memory polymer-CNT composite as a function of input voltage. Shape recovery was also possible at 2V, with a recovery time of 98 seconds. FIG. 4E provides screenshots of the shape recovery experiment under 10V. FIG. 4F provides a shape memory experiment performed with a commercial AA battery pack, where a glass rod held up by the SMP composite is released when shape change is triggered electrically.

FIG. 5 provides the Raman spectra of long DWNT foam samples (FIG. 5A) and short SWNT foam samples (FIG. 5B) using a 514.5 nm laser as the excitation source.

FIG. 6 shows the x-ray photoelectron spectroscopy (XPS) spectra of a CNT foam sample. The appearance of silicon in the annealed sample is likely due to contamination of the oven used in the annealing process.

FIG. 7 shows the mass retained by as-fabricated CNT foams as a function of temperature, measured using a Q600 TGA/DSC apparatus in an inert Argon atmosphere. The sample was heated from room temperature to 130° C., then held at 130° C. for 30 minutes to estimate the mass loss due to moisture, then heated to 500° C. to estimate the mass loss due to residual sulfur in the sample.

FIG. 8 shows optical microscopy images of CNT-CSA solutions in 1 mm thick glass capillaries under cross-polarized light.

FIG. 9 shows scanning electron microscopy (SEM) images of dry CNT foams at different foam densities for both long DWNT foams (left) and short SWNT foams (right).

FIG. 10 shows transmission electron microscopy (TEM) images of dry CNT foams at comparable foam density, for both long DWNT foams (left) and short SWNT foams (right). The black dots found in the SWNT image are residual CNT catalyst particles.

FIG. 11 shows SEM images of a piece of dry DWNT foam (left) and a piece of DWNT foam after PDMS infiltration (right).

FIG. 12 shows various data relating to DWNT and SWNT foams, including N₂ gas adsorption/desorption isotherms (FIG. 12A) and sample surface area as calculated using the Brunauer-Emmett-Teller (BET) analysis technique produced by the Quantrotome software (FIG. 12B) for a sample of long DWNT foam at a bulk density of 15 mg/cm³ and a short SWNT foam at a bulk density of 16 mg/cm³. The rapid rise in the isotherm and the hysteresis near P/P₀=1 are characteristic of macroporous materials (type IV isotherms). FIG. 12C shows the use of the t-plot method to calculate the micropore surface area from the “rounded knee” in the isotherms at low relative pressure. FIG. 12D shows the pore size distribution calculated using the Barrett-Joyner-Halenda (BJH) model, using the desorption isotherm. FIG. 12E shows a summary of the results from the physisorption analysis.

FIG. 13 shows a representative stress-strain curve at 60% compression, for a sample of long DWNT foam at 15 mg/cm³ (FIG. 13A) and a short SWNT foam at 16 gm/cm³ (FIG. 13B).

FIG. 14 provides dynamic mechanical analysis (DMA) experiments under compression. The storage modulus (E′), loss modulus (E″), and damping coefficient (tan δ) are measured for long DWNT foam (FIG. 14A) and short SWNT foam (FIG. 14B) as a function of frequency at 1% strain amplitude, and as a function of cyclic loading for long DWNT foam (FIG. 14C) and short SWNT foam at 1 Hz (FIG. 14D).

FIG. 15 provides representative stress-strain curves and related images for tensile tests of a sample of short SWNT foam at 16 gm/cm³ (FIG. 15A) and long DWNT foam at 15 mg/cm³ (FIG. 15B). Images of the tensile experiments for a specimen of short SWNT (FIG. 15C), and long DWNT foams (FIG. 15D), respectively, as well as the SEM images of the broken ends. While the short SWNT foam broke easily with a relatively smooth broken cross-section, the long DWNT foam was strengthened by the strong, string-like CNT bundles within the sample.

FIG. 16 provides specific electrical conductivity values as a function of average foam density. The measurement method (two-probe versus four-probe) is indicated in the figure legend.

FIG. 17 provides the conductivity of a long DWNT foam sample (density ˜11 mg/cm³) over 30 days, measured using both the two-probe and the four-probe method.

FIG. 18 shows data relating to the absorption ratio (mass oil absorbed/mass foam) as a function of sample bulk density for foams reported in this work (closed symbols) and values previously reported in literature for CVD foams (open symbols). The images on the right shows a piece of compressed DWNT foam preferentially absorbing oil on top of a layer of water, and expanding to its original size. The absorbed oil can either be squeezed out (the photograph shows oil accumulated in the beaker from 10 foam samples), or the oil can be recovered by immersing the foam in petroleum ether. The compressed piece of foam can then be re-used.

FIG. 19 provides data relating to the use of CNT foams as magnetic nanoparticles. FIG. 19A provides SEM images of DWNT foams loaded with magnetic cobalt nanoparticles by simple gravity filtration. FIG. 19B shows the lightweight DWNT foam (15 mg/cm³) loaded with magnetic nanoparticles being picked up by a handheld magnet. FIG. 19C provides a hysteresis loop measured at room temperature for the DWNT foam loaded with the magnetic nanoparticles.

FIG. 20 provides data relating to the recovery time for the shape memory polymer-CNT composite as a function of input voltage. At voltages below 2V, the sample did not recover within 120 seconds. Above 12V, the sample recovered its shape quickly but overheated. The images on the right shows screenshots of a shape recovery experiment as monitored using an infrared visual thermometer.

FIG. 21 provides additional data relating to the characterization of CNT foams. FIG. 21A shows the bulk density of the synthesized dry foams as a function of initial solution concentration of CNT in chlorosulfonic acid. FIG. 21B shows the porosity of the synthesized dry foams as a function of initial solution concentration of CNT in chlorosulfonic acid. The porosity values are calculated based on the measured bulk density of the foam samples and the density of the CNTs reported in literature.

FIG. 22 provides measured Young's modulus values of CNT foams for compression tests at 60% strain (for the first cycle of compression) as a function of average foam density. The foam samples in this work are reported as closed symbols, while values of CNT foams in previous literature are shown in open symbols. For Gui et al. (ACS Nano 2010, 4, 2320-2326), the values are reported for 60% compression, while for Worsley et al. (Appl. Phys. Lett., 2009, 94, 073115), the values for the Young's modulus are reported for up to 78% compression. For Worsley et al., the <16% or >16% refers to the % CNT in the final foam sample (the rest is amorphous carbon). Hashim et al. refers to Sci. Rep., 2012, 2, 2-8.

FIG. 23 provides percent plastic deformation for CNT foam samples at 60% compression (for the first cycle of compression) as a function of average bulk density. The foam samples in this work are reported as closed symbols, while values of CNT foams in previous literature are shown in open symbols.

FIG. 24 provides specific conductivity of the synthesized CNT foams as function of average bulk density. The foam samples in this work are reported as closed symbols. Specific conductivity values of CNT foams in previous literature are shown in open symbols. The conductivity values in this work, in Gui et al. (Adv. Mater., 22, 617-621, 2010), and in Bryning et al. (Adv. Mat., 2007, 19, 661-664) are measured using a two-probe method, while the values in Hashim et al. (Sci. Rep., 2012, 2, 2-8), Thongprachan et al. (Mat. Chem. Phys., 2008, 112, 262-269), and Worsley et al. (Appl. Phys. Lett., 2009, 94, 073115) are measured using a four-probe method.

FIG. 25 provides Young's moduli of compression at 60% strain (for the first cycle of compression) for the different types of CNT-polymer composites produced through direct infiltration.

FIG. 26 provides percent plastic deformation at 60% compression (for the first cycle of compression) for the different types of CNT-polymer composites produced through direct infiltration. The PDMS-CNT composite showed little to no plastic deformation, as well as the hydrogel sample after re-immersion in water for 5 minutes. The % plastic deformation for the re-immersed hydrogel-CNT composite sample was determined by comparing the measured the sample height before compression and after re-immersion.

FIG. 27 provides electrical conductivity for the different types of CNT-polymer composites produced through direct infiltration. The composites in all cases were able to retain over 50% of the conductivity of the original CNT foam.

FIG. 28 provides electrical conductivity of CNT-polymer composites (either epoxy or PDMS) in this work (closed symbols) and composites previously reported in literature fabricated through direct polymer infiltration (open symbols), as a function of % CNT loading by weight. Gui et al. (ACS Nano, 2010, 4, 2320-2326; ACS Nano, 2011, 5, 4276-428) performed infiltration on multi-walled carbon nanotube (MWNT) foams produced through a CVD process, while Worsley et al. (Appl. Phys. Lett., 2009, 94, 073115) produced CNT foams through solution processing in a sol-gel process. The dotted line indicates the highest conductivity achieved for composites fabricated through mixing of individual CNTs into the polymer matrix (Sandler et al., Polymer, 2003, 44, 5893-5899). Composites fabricated using direct infiltration have significantly higher conductivity values compared to composites made by mixing.

FIG. 29 provides SEM images of graphene-based foams. FIG. 29A provides SEM images of foams that consist of 100% graphene. FIG. 29B provides SEM images of foams that consist of mixtures of CNT and graphene.

FIG. 30 provides data relating to the properties of graphene-based foams in the presence of increasing concentration of CNTs. FIG. 30A provides a graph illustrating the effect of CNT on the densities of graphene-based foams. FIG. 30B provides a graph illustrating the effect of CNT on the surface areas of graphene-based foams.

FIG. 31 shows the morphology change of DWNT nanotube foams when triethylamine (2 volume %) was incorporated into an ether coagulation bath and the coagulation temperature was reduced from 25° C. to 0° C. An image of a formed DWNT foam treated in an ether coagulation bath at 25° C. is shown in FIG. 31A. An image of a formed DWNT foam treated in an ether and triethylamine (2 volume %) coagulation bath at 0° C. is shown in FIG. 31B.

FIG. 32 shows a morphology change in DWNT foams when sodium dodecyl sulfate (SDS) is incorporated into a superacid solution prior to coagulation. An image of a formed DWNT foam that was coagulated in ether in the absence of additives is shown in FIG. 32A. An image of a formed DWNT foam that was coagulated in an ether and dichloromethane bath in the presence of 1.25% SDS is shown in FIG. 32B.

FIG. 33 shows a morphology change in DWNT foams when silica particles are incorporated into a superacid solution and coagulated using a coagulation bath of ether at room temperature. An image of a formed DWNT foam that was coagulated in ether in the absence of additives is shown in FIG. 33A. Images of formed DWNT foams that were coagulated in ether in the presence of 7.5% and 10% silica particles are shown in FIGS. 33B and 33C, respectively.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Various methods may be utilized to grow carbon foam structures. For instance, some methods involve the direct growth of the carbon source (e.g., carbon nanotubes) into a foam-like structure through chemical vapor deposition (CVD) systems. Such direct growth yields materials with low density and good mechanical properties. However, such direct growth can yield materials with poor electrical and thermal conductivity (e.g., below ˜170 S/m), potentially due to high defect density. Furthermore, because growth is off of a surface, CVD appears to be poorly scalable.

Accordingly, many methods have relied on fluid-based processing of carbon sources to develop carbon foam structures. However, fluid-based methods typically rely on either functionalization or sonication of the carbon sources. Such processing steps can compromise the surface integrity of the carbon sources, thereby leading to reduced strength and electrical conductivity (below ˜300 S/m). As such, a need exists for improved methods of making carbon foams for various purposes. The present disclosure addresses this need.

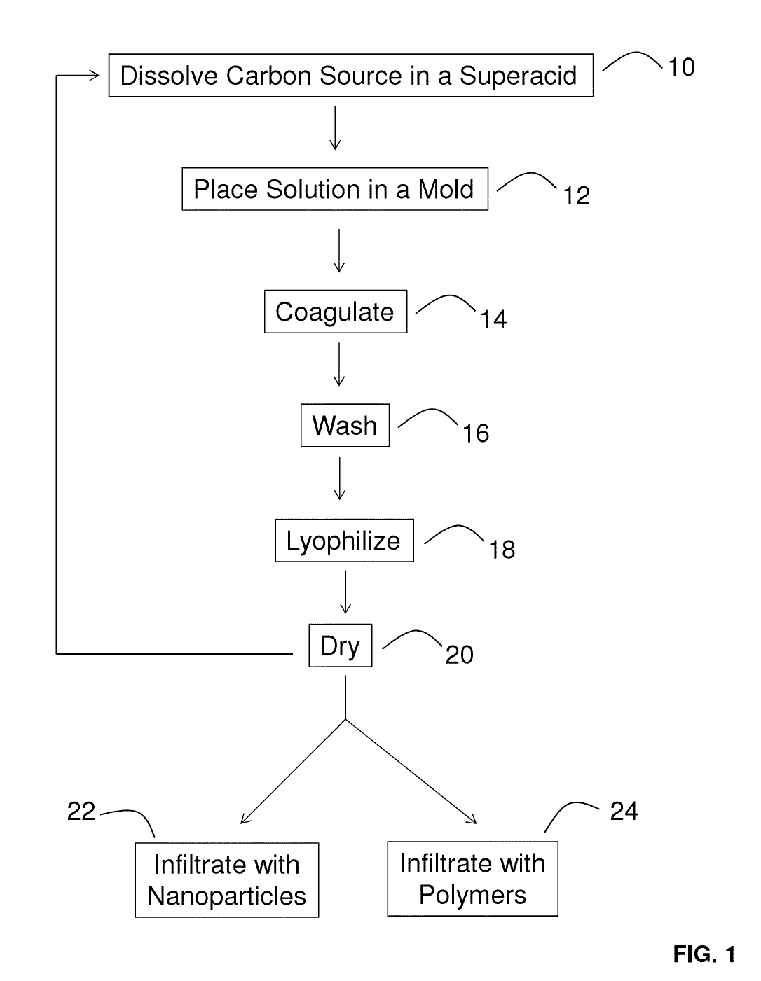

In some embodiments, the present disclosure pertains to methods of making carbon foams. In some embodiments that are illustrated in FIG. 1, the methods of the present disclosure include: dissolving a carbon source in a superacid to form a solution (step 10); placing the solution in a mold (step 12); and coagulating the carbon source after placing the solution in the mold (step 14). In some embodiments, the methods of the present disclosure may also include a subsequent step of washing the coagulated carbon source (step 16). In some embodiments, the methods of the present disclosure may also include a step of lyophilizing the coagulated carbon source (step 18). In some embodiments, the methods of the present disclosure may also include a step of drying the coagulated carbon source (step 20). In some embodiments, the methods of the present disclosure may also include one or more steps of infiltrating the formed carbon foams with nanoparticles (step 22) and/or polymers (step 24). In some embodiments, the formed carbon foams may be recycled through the aforementioned steps.

In some embodiments, the methods of the present disclosure occur without the use of surfactants. In some embodiments, the methods of the present disclosure occur without the use of organic binders. In some embodiments, the methods of the present disclosure occur without the use of sonication. In some embodiments, the methods of the present disclosure occur without the use of chemical vapor deposition. In some embodiments, the methods of the present disclosure occur without the use of surfactants, organic binders, sonication, or chemical vapor deposition. Further embodiments of the present disclosure pertain to the carbon foams that are formed in accordance with the above methods.

As set forth in more detail herein, the methods of the present disclosure have numerous variations. For instance, various carbon sources, superacids, carbon source dissolution methods, coagulation methods, washing steps, lyophilization steps, and drying steps may be utilized to make various types of carbon foams. Various methods may also be used to infiltrate the formed carbon foams with various nanoparticles and polymers.

Carbon Sources

The methods of the present disclosure may utilize various types of carbon sources to make various types of carbon foams. In some embodiments, the carbon sources may include at least one of graphenes, fullerenes, fluorenes, carbon nanotubes, and combinations thereof.

In some embodiments, the carbon sources may include carbon nanotubes. In some embodiments, the carbon nanotubes may include pristine carbon nanotubes. In some embodiments, the carbon nanotubes may include un-functionalized carbon nanotubes. In some embodiments, the carbon nanotubes may include, without limitation, single-wall carbon nanotubes (SWNTs), short single-wall carbon nanotubes (i.e., SWNTs with lengths of about 500 nm or less), ultra-short single-wall carbon nanotubes (i.e., SWNTs with lengths of about 60 nm of less), double-wall carbon nanotubes (DWNTs), multi-wall carbon nanotubes (MWNTs), and combinations thereof.

In some embodiments, the carbon sources may include short single-wall carbon nanotubes. In some embodiments, the short single-wall carbon nanotubes may have lengths of about 500 nm and diameters of about 1 nm. In some embodiments, the carbon sources may include double-wall carbon nanotubes. In some embodiments, the double-wall carbon nanotubes may have lengths of about ˜10 μm and diameters of about ˜2.4 nm.

In some embodiments, the carbon sources used to make carbon foams may only contain carbon nanotubes. In some embodiments, the carbon sources used to make carbon nanotubes may only contain short single-wall carbon nanotubes, such as short single-wall carbon nanotubes with lengths of about 500 nm and diameters of about 1 nm. In some embodiments, the carbon sources may only include double-wall carbon nanotubes, such as double-wall carbon nanotubes with lengths of about ˜10 μm and diameters of about ˜2.4 nm.

In some embodiments, the carbon sources used to make carbon foams may only contain graphenes. In some embodiments, the carbon sources used to make carbon foams may contain mixtures of carbon nanotubes and graphenes.

Superacids

The carbon sources of the present disclosure may be dissolved in various types of superacids to form a solution. In some embodiments, the superacids may include, without limitation, perchloric acid, chlorosulfonic acid, fluorosulfonic acid, trifluoromethane sulfonic acid, methane sulfonic acid, perfluoroalkane sulfonic acids, fluorosulfonic acid, triflic acid, antimony pentafluoride, arsenic pentafluoride, oleums, polyphosphoric acid-oleum mixtures, tetra(hydrogen sulfate)boric acid-sulfuric acid, fluorosulfuric acid-antimony pentafluoride, fluorosulfuric acid-SO₃, fluorosulfuric acid-arsenic pentafluoride, fluorosulfonic acid-hydrogen fluoride-antimony pentafluoride, fluorosulfonic acid-antimony pentafluoride-sulfur trioxide, fluoroantimonic acid, tetrafluoroboric acid, and combinations thereof.

In some embodiments, the superacid may include chlorosulfonic acid. In more specific embodiments, the superacid includes chlorosulfonic acid, and the carbon source includes carbon nanotubes, such as pristine and un-functionalized carbon nanotubes. In some embodiments, the pristine and un-functionalized carbon nanotubes are dissolved in chlorosulfonic acid without causing any significant sidewall damage to the carbon nanotubes.

In some embodiments, the superacid may be one or more of a Brønsted superacid, a Lewis superacid, and/or a conjugate Brønsted-Lewis superacid. In some embodiments, Brønsted superacids may include, without limitation, perchloric acid, chlorosulfonic acid, fluorosulfonic acid, trifluoromethane sulfonic acid, methane sulfonic acid, higher perfluoroalkane sulfonic acids (C₂F₅SO₃H, C₄F₉SO₃H, C₅F₁₁SO₃H, C₆F₁₃SO₃H, and C₈F₁₇SO₃H, for example), and combinations thereof.

In some embodiments, Lewis superacids may include, without limitation, antimony pentafluoride and arsenic pentafluoride. In some embodiments, Brønsted-Lewis superacids may include oleums. Other suitable Brønsted-Lewis superacids may include, without limitation, polyphosphoric acid-oleum mixtures, tetra(hydrogen sulfate)boric acid-sulfuric acid, fluorosulfuric acid-antimony pentafluoride (“magic acid”), fluorosulfuric acid-SO₃, fluorosulfuric acid-arsenic pentafluoride, fluorosulfonic acid-hydrogen fluoride-antimony pentafluoride, fluorosulfonic acid-antimony pentafluoride-sulfur trioxide, fluoroantimonic acid, tetrafluoroboric acid, and combinations thereof.

Dissolution of Carbon Sources in Superacids

Various methods may also be utilized to dissolve carbon sources in superacids. In some embodiments, the dissolution occurs by mixing. In some embodiments, the mixing occurs by utilizing a mixer, such as a high shear mixer. In some embodiments, the dissolution of carbon sources in superacids occurs spontaneously upon combining carbon sources with superacids. In some embodiments, the dissolution of carbon sources in superacids occurs without the use of sonication.

Solutions

In some embodiments, the solutions of the present disclosure may only consist of superacids and carbon sources. In some embodiments, the solutions of the present disclosure may also include one or more additives. In some embodiments, the additives may be associated with carbon sources during coagulation. In some embodiments, the additives may include, without limitation, surfactants, silica particles, polymer particles, metal particles, organic solvents, amine-based solvents, fluorinated organic solvents, hydrophobic organic solvents, and combinations thereof. In more specific embodiments, the additives include one or more surfactants, such as sodium dodecyl sulfate (SDS). In some embodiments, the additives may help control the structure of the formed carbon foams during coagulation.

Molds

The solutions of the present disclosure may be placed in various types of molds. In some embodiments, the molds may have various shapes. For instance, in some embodiments, the molds may be cubic in structure. In some embodiments, the molds may be cylindrical in structure. In some embodiments, the molds may be rectangular in structure. In some embodiments, the molds may be wrapped in Teflon tape. In some embodiments, the molds may be made of stainless steel mesh sheets.

The molds of the present disclosure may also have various sizes. For instance, in some embodiments, the molds of the present disclosure may have surface areas that range from about 1 mm² to about 100 m². Additional sizes can also be envisioned.

Various methods may also be utilized to place the solutions of the present disclosure into molds. In some embodiments, the solutions may be placed into molds by pouring the solutions into the molds. In some embodiments, the solutions of the present disclosure may be placed into molds by pipetting. In some embodiments, the solutions of the present disclosure may be placed into molds by injection. In some embodiments, the solutions of the present disclosure may be placed into molds by extruding the solution into the mold. Additional methods of placing solutions into molds can also be envisioned.

Coagulation

Various methods may also be used to coagulate the carbon sources in the solutions of the present disclosure. In some embodiments, the coagulating occurs after the solutions of the present disclosure are placed in a mold. In some embodiments, the coagulating occurs by exposing the solutions of the present disclosure to a solvent. In some embodiments, the solvent may include at least one of ether, isopropanol, water, acetone, dichloromethane, chloroform, tetrahydrofuran, triethylamine, and combinations thereof. In some embodiments, the solvent is ether. In some embodiments, the solvent is chloroform. In some embodiments, the solvent is a combination of ether and another solvent in various ratios. For instance, in some embodiments, the solvent is a combination of ether and chloroform. In some embodiments, the ratio of ether to chloroform in the solvent is 10:90. In some embodiments, the solvent is a combination of ether and dichloromethane. In some embodiments, the ratio of ether to dichloromethane in the solvent is 10:90. In some embodiments, the solvent is a combination of ether and triethylamine. In some embodiments, the ratio of ether to triethylamine in the solvent is 98:2.

In some embodiments, the solvent is kept at room temperature during coagulation (e.g., 25° C.). In some embodiments, the solvent is cooled during coagulation (e.g., cooled to 0° C., −78° C., or −196° C.). In some embodiments, the solvent is heated during coagulation.

In some embodiments, a coagulation bath may be used to coagulate the carbon sources in the solutions of the present disclosure. In some embodiments, the coagulation bath contains one or more solvents, as previously described. In some embodiments, the coagulation bath may be cooled during coagulation. In some embodiments, the coagulation bath may be cooled during coagulation. In some embodiments, the coagulation bath may be heated during coagulation. In some embodiments, the coagulation bath may be kept at 25° C. during coagulation. In some embodiments, the coagulation bath may be cooled to 0° C. during coagulation. In some embodiments, the coagulation bath may be cooled to −78° C. during coagulation. In some embodiments, the coagulation bath may be cooled to −196° C. during coagulation.

Various methods may also be used to expose the solutions of the present disclosure to solvents in order to promote the coagulation of the carbon sources. For instance, in some embodiments, the solutions of the present disclosure may be exposed to solvents by submerging a mold that contains the solution into the solvent. In more specific embodiments, molds containing the solutions of the present disclosure may be immersed in a solvent bath. In some embodiments, the solutions of the present disclosure may be immersed in a solvent for prolonged periods of time. For instance, in some embodiments, coagulation occurs by submerging the mold in a bath of solvent for 2 hours.

Washing

In some embodiments, the methods of the present disclosure also include a step of washing the coagulated carbon source. In some embodiments, the washing occurs immediately after coagulating. In some embodiments, washing comprises exposing the coagulated carbon source to one or more solvents. For instance, in some embodiments, the coagulated carbon source may first be exposed to water to remove any residual acid. The coagulated carbon source may then be exposed to isopropanol followed by deionized water.

Lyophilization

In some embodiments, the methods of the present disclosure also include a step of lyophilizing the coagulated carbon source. In some embodiments, the lyophilization comprises a free-drying step. For instance, in some embodiments, lyophilization occurs by flash-freezing the coagulated carbon source in liquid nitrogen and freeze-drying at ˜45° C. overnight using a freeze dryer unit.

Drying

In some embodiments, the methods of the present disclosure can also include a further step of drying the formed carbon foams. Various methods may also be used to dry the formed carbon foams of the present disclosure. For instance, in some embodiments, the drying can occur in an oven, such as an oven heated to 150° C.

The drying can also occur for various periods of time. For instance, in some embodiments, the drying can occur anywhere from about 1 hour to about 5 hours. In some embodiments, the drying occurs for about 2 hours.

Nanoparticle Infiltration

In some embodiments, the methods of the present disclosure may also include a step of infiltrating the formed carbon foams with nanoparticles. In some embodiments, the infiltration may include exposing the formed carbon foams to a solution containing nanoparticles. In some embodiments, the formed carbon foams may be immersed in a solution of nanoparticles. In some embodiments, the nanoparticle-infiltrated carbon foams may be washed, dried and/or lyophilized after the infiltration (as previously described).

The formed carbon foams of the present disclosure may be exposed to various types of nanoparticles. In some embodiments, the nanoparticles may include magnetic nanoparticles. In some embodiments, the magnetic nanoparticles may include, without limitation, iron nanoparticles, nickel nanoparticles, cobalt nanoparticles, and combinations thereof. In some embodiments, the magnetic nanoparticles may include cobalt nanoparticles.

Polymer Infiltration

In some embodiments, the methods of the present disclosure may also include a step of infiltrating the formed carbon foams with polymers. In some embodiments, the infiltration may include exposing the formed carbon foams to a solution containing polymers. In some embodiments, the formed carbon foams may be immersed in a solution of polymers. In some embodiments, a solution of polymers may be added to the formed carbon foams by drop-wise addition.

In some embodiments, the polymers may include at least one of polydimethylsiloxane (PDMS), polyvinyl alcohol (PVA), polyethylene glycol (PEG), cross-linked polymer hydrogels, poly (epoxides) (epoxy resins), and combinations thereof. In some embodiments, the polymers may include epoxy polymers, such as shape memory epoxy polymers.

In some embodiments, polymer infiltration into formed carbon foams may occur by: (a) embedding the formed carbon foams with polymer precursors; and (b) polymerizing the polymer precursors. In some embodiments, polymer precursor infiltration may occur by exposing the formed carbon foams to a solution containing polymer precursors. In some embodiments, the formed carbon foams may be immersed in a solution of polymer precursors. In some embodiments, a solution of polymer precursors may be added to the formed carbon foams by drop-wise addition.

In some embodiments, the polymer precursors may include epoxy resins. In some embodiments, the polymer precursor solution may also include a curing agent (e.g., a cross-linker).

Various methods may also be used to polymerize the polymer precursors in the formed carbon foams. In some embodiments where a curing agent is present in the polymer precursor solution, the polymerization may occur spontaneously. In some embodiments, the polymerization may occur by heating. For instance, in some embodiments, the polymerization may occur by heat curing, such as heat curing for about 2 hours. In some embodiments, the polymerization may occur by freeze drying, such as free-drying for about 6 hours. In some embodiments, the polymerization may occur by UV irradiation. In some embodiments, the polymerizing may also include a step of adding a curing agent (e.g., a cross-linker) to the formed carbon foams. In some embodiments, the polymer-infiltrated carbon foams may be washed, dried and/or lyophilized after infiltration (as previously described).

Carbon Foams

The methods of the present disclosure may be utilized to make various types of carbon foams. In some embodiments, the carbon foams are freestanding. In some embodiments, the carbon foams are hydrophobic. In some embodiments, the carbon foams of the present disclosure include a carbon source that forms a continuous and three-dimensional network.

In addition, the carbon foams of the present disclosure can have various types of carbon sources. For instance, in some embodiments, the carbon foams of the present disclosure have carbon sources selected from the group consisting of graphenes, fullerenes, fluorenes, carbon nanotubes, and combinations thereof. In some embodiments, the carbon foams of the present disclosure contain carbon nanotubes as carbon sources. In some embodiments, the carbon nanotubes are selected from the group consisting of single-wall carbon nanotubes, short single-wall carbon nanotubes, ultra-short single-wall carbon nanotubes, double-wall carbon nanotubes, multi-wall carbon nanotubes, pristine carbon nanotubes, un-functionalized carbon nanotubes and combinations thereof.

In more specific embodiments, the carbon sources in the carbon foams of the present disclosure include continuous networks of isotropic carbon nanotubes. In some embodiments, the carbon sources in the carbon foams of the present disclosure consist essentially of carbon nanotubes. In some embodiments, carbon foams of the present disclosure consist essentially of graphene. In some embodiments, the carbon foams of the present disclosure consist essentially of carbon nanotubes and graphene.

In some embodiments, the carbon foams of the present disclosure include pristine carbon nanotubes. In some embodiments, the carbon foams of the present disclosure un-functionalized carbon nanotubes. In some embodiments, the carbon foams of the present disclosure include continuous networks of isotropic carbon nanotubes. In some embodiments, the carbon foams of the present disclosure include an interconnected network of self-assembled carbon nanotube bundles.

In addition, the carbon foams of the present disclosure can have various concentrations of carbon nanotubes. For instance, in some embodiments, the carbon foams of the present disclosure have a carbon nanotube content ranging from about 5% to about 95%.

The carbon foams of the present disclosure can also have various surface areas. For instance, in some embodiments, the carbon foams of the present disclosure have a surface area between about 150 m²/g and about 1000 m²/g. In some embodiments, the carbon foams of the present disclosure have a surface area between about 400 m²/g and about 900 m²/g. In more specific embodiments, carbon foams containing DWNTs may have surface areas of about 644 m²/g. In further embodiments, carbon foams containing short SWNTs may have surface areas of about 824 m²/g.

The carbon foams of the present disclosure can also have various ranges of electrical conductivity. For instance, in some embodiments, the carbon foams of the present disclosure have an electrical conductivity greater than about 10 S/cm. In more specific embodiments, the carbon foams of the present disclosure have an electrical conductivity of about ˜1900 S/cm. In some embodiments, the carbon foams of the present disclosure have a specific conductivity of about 0.1 kSm²/kg.

The carbon foams of the present disclosure can also have various densities. For instance, in some embodiments, the carbon foams of the present disclosure have a density between about 4.5 mg/cm³ to about 70 mg/cm³. In some embodiments, the carbon foams of the present disclosure have densities that range from about 10 mg/cm³ to about 25 mg/cm³. In some embodiments, the carbon foams of the present disclosure have densities that range from about 15 mg/cm³ to about 16 mg/cm³. In some embodiments, the carbon foams of the present disclosure have densities of about 5 mg/cm³.

The carbon foams of the present disclosure can also vary in strength. For instance, in some embodiments, the carbon foams of the present disclosure have a Young's modulus between about 1 MPA to about 10,000 MPA at 60% strain. In some embodiments, the carbon foams of the present disclosure have a Young's modulus ranging from about 30 MPA to about 4,000 MPA at 60% strain. In more specific embodiments, the carbon foams of the present disclosure have a Young's modulus of about 4,000 MPA at 60% strain.

The carbon foams of the present disclosure can also have various ranges of porosities. For instance, in some embodiments, the carbon foams of the present disclosure have porosities greater than about 95%. In more specific embodiments, the carbon foams of the present disclosure have porosities greater than about 99%.

The carbon foams of the present disclosure can also have various types of pores. For instance, in some embodiments, the carbon foams of the present disclosure may include at least one of micropores (pores with diameters of <2 nm), mesopores (pores with diameters of 2 nm-50 nm), macropores (pores with diameters of >50 nm), and combinations thereof.

In some embodiments, the carbon foams of the present disclosure also include infiltrated nanoparticles. In some embodiments, the infiltrated nanoparticles include magnetic nanoparticles, such as iron nanoparticles, nickel nanoparticles, cobalt nanoparticles, and combinations thereof.

In some embodiments, the carbon foams of the present disclosure also include infiltrated polymers. In some embodiments, the infiltrated polymers include, without limitation, polydimethylsiloxane (PDMS), polyvinyl alcohol (PVA), polyethylene glycol (PEG), cross-linked polymer hydrogels, poly (epoxides), and combinations thereof.

In some embodiments, the carbon foams of the present disclosure also include one or more additives. In some embodiments, the additives may include, without limitation, surfactants, silica particles, polymer particles, metal particles, organic solvents, amine-based solvents, fluorinated organic solvents, hydrophobic organic solvents, and combinations thereof. In more specific embodiments, the additives include one or more surfactants, such as sodium dodecyl sulfate (SDS).

Applications and Advantages

The carbon foams made by the methods of the present disclosure provide a unique combination of low density, high mechanical modulus, high surface area, high compressive modulus, high electrical conductivity, high thermal conductivity and high transport properties. For instance, in some embodiments, the carbon foams of the present disclosure can have specific thermal conductivities comparable to metal foams while being about ten times lighter than metal foams.

Furthermore, the methods of the present disclosure can be scaled and controlled to form carbon foams with various morphologies, densities, and mechanical properties. For instance, in some embodiments, the density of the formed carbon foam is controllable by varying carbon source concentration, where lower carbon source concentrations lead to the formation of carbon foams with lower densities, and where higher carbon source concentrations leads to the formation of carbon foams with higher densities. In some embodiments, the porosity of the formed carbon foam is controllable by varying carbon source concentration, where lower carbon source concentrations leads to the formation of carbon foams with higher porosities, and where higher carbon source concentrations leads to the formation of carbon foams with lower porosities.

In more specific embodiments, the porosities and densities of carbon nanotube foams can be controlled by varying the types and concentrations of carbon nanotubes utilized during carbon nanotube foam formation. For instance, in some embodiments, carbon nanotube length and initial carbon nanotube concentration can be varied to achieve carbon nanotube foam densities as low as 5 mg/cm³, and carbon nanotube foam porosities greater than 99%.

Accordingly, the methods of the present disclosure can be utilized to form carbon foams for various applications. For instance, in some embodiments, the carbon foams of the present disclosure may be utilized in applications involving aerospace thermal management, energy storage, conductive scaffolds for tissue engineering, energy dissipation, catalysis, batteries, sensors, supercapacitors, electrodes, fuels cells, and the like. In more specific embodiments, the carbon foams of the present disclosure may be utilized for oil absorption.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Production of Highly Conductive, Ultra-Light Multifunctional Carbon Nanotube Solid Foams by Scalable Solution Processing

In this Example, Applicants report the fabrication of porous foam-like, three-dimensional structures consisting of interconnected pristine single or few-walled carbon nanotubes (CNTs) by solution processing. This scalable process preserves the length and quality of the CNTs and yields mechanically robust, yet soft macroscopic materials with unprecedented electrical conductivity values for low-density materials (1900 S/m at 14.7 mg/cm³ and 99% porosity). These CNT foams match the specific thermal conductivity of metal foams but are ten to a hundred times lighter. Direct infiltration of CNT foams with polymers yields structures with conductivities 100 times higher than traditional composites processed by directly mixing individual CNTs with polymer. Infiltrated CNT foams form electrically triggered shape memory materials with the best performance to date.

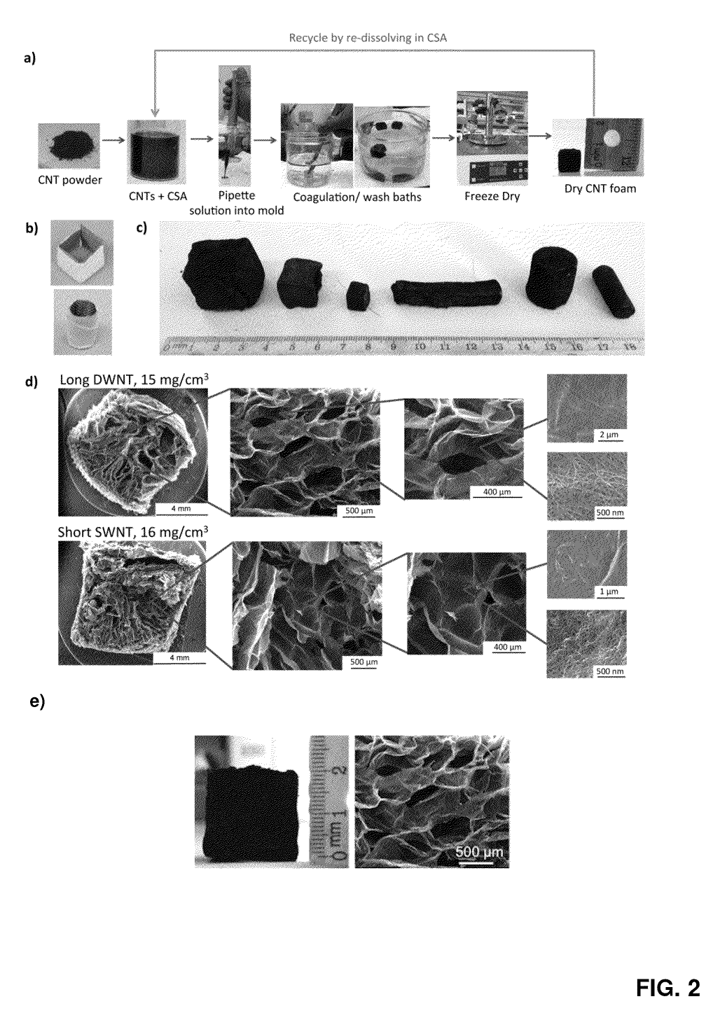

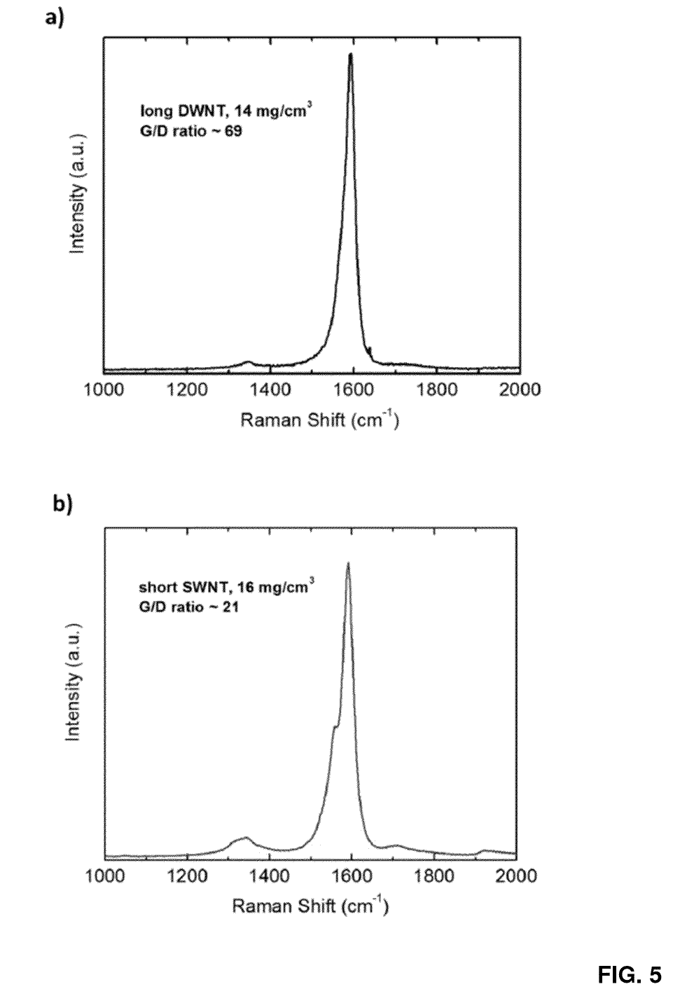

FIG. 2A outlines the foam fabrication method for this Example, which relies on spontaneous (sonication-free) CNT dissolution in chlorosulfonic acid (CSA) and parallels the injection molding process widespread in polymer processing. The CNT-CSA solution is then dispensed into molds and coagulated in an ether bath, removing the acid and inducing CNT self-assembly. The solidified foam samples are then removed from the molds, washed, and freeze-dried, yielding the final dry foams, whose shapes and sizes conform to the molds (FIGS. 2B-C). The CNTs in the final material are undamaged, as shown by the high Raman G/D ratio of the dry foams (FIG. 5), and can be recycled by re-dissolution in CSA.

In this Example, Applicants fabricated foams with two types of CNTs: short single-walled CNTs (HiPco, length L˜0.5 μm, diameter D˜1 nm) (hereafter termed “short SWNTs”) and longer few-walled (predominantly double-walled) CNTs (L˜10 μm, D˜2.4 nm) (hereafter termed “long DWNTs”).

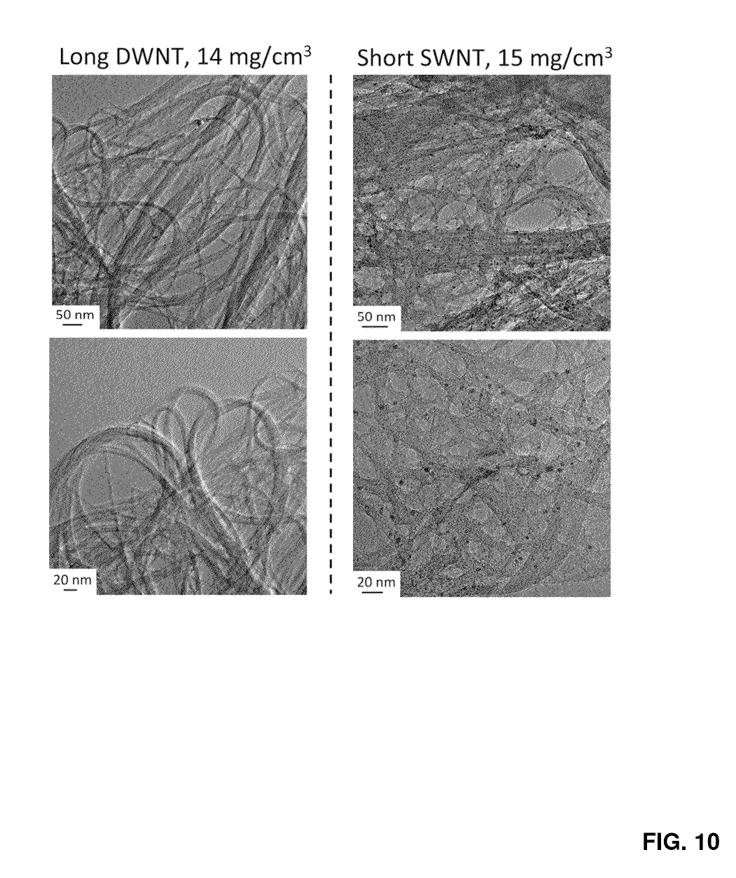

FIG. 2D shows scanning electron microscopy (SEM) images. The CNTs self-assembled into hierarchical porous structures with empty pockets surrounded by thin membranes consisting of highly entangled CNT bundles. The overall structure resembles closed-cell polymer foams. However, the membranes are permeable and the internal surfaces of the foams remain accessible, as reflected by the high specific surface area measured in nitrogen adsorption experiments (400-900 m²/g depending on the foam density, 644 m²/g for long DWNT foams and 824 m²/g for short SWNT foams at ˜99% porosity). Analysis of the nitrogen adsorption isotherms suggests that the samples contain both micropores (<2 nm) and meso- or macropores (>50 nm), consistent with the hierarchical morphology observed under SEM (FIG. 10).

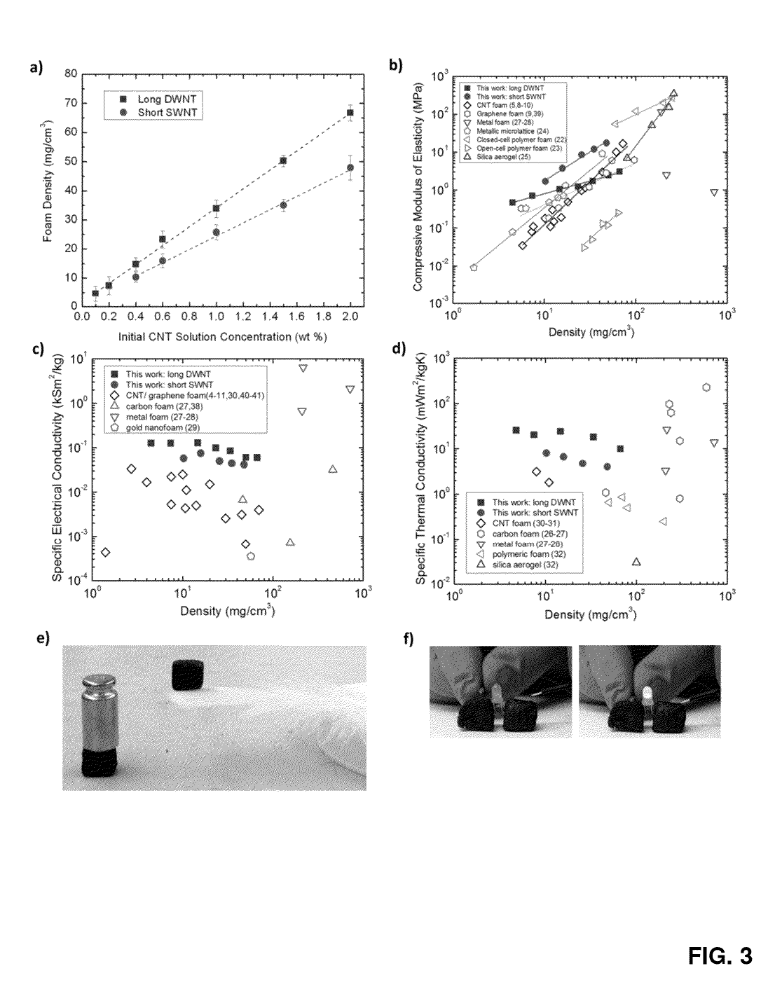

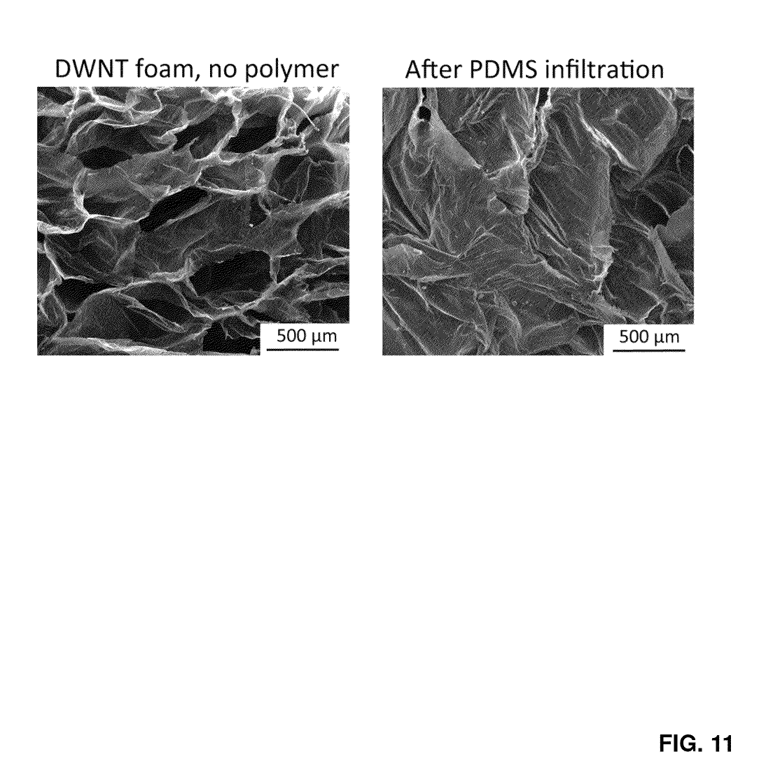

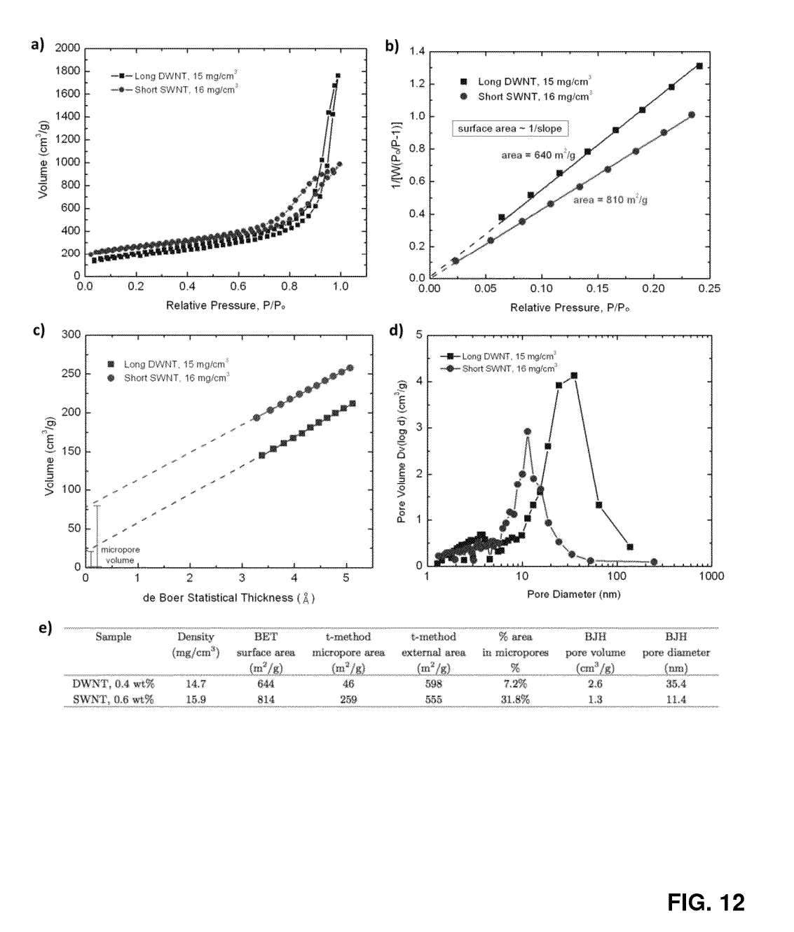

The bulk density and porosity of the foams can be controlled by simply varying the initial CNT solution concentration (FIG. 3A), down to a density of 4.5 mg/cm³, corresponding to >99.5% porosity (for comparison, marshmallows are ˜200 mg/cm³ and polyurethane foams are typically ˜15-150 mg/cm³). The compressive modulus of elasticity (sometimes reported as compressive Young's modulus in many works) scales with foam density as a power-law with an exponent of 0.8 for long DWNT foams and 1.5 for short SWNT foams (FIG. 3B and FIG. 11), indicating that the foams' bulk mechanical response resembles that of closed-celled polymeric foams (exponent<2), consistent with the morphology observed under SEM. The compressive moduli of elasticity reported here (between 0.5-13 MPa depending on foam density, close to the ˜30 MPa typical modulus of a marshmallow and ˜0.3-11 MPa modulus range of polyurethane foams) are comparable to or higher than all known cellular materials at comparable densities, likely due to the closed-cell macroscopic structure, as closed-cell polymeric foams are generally stiffer than open-celled ones. The foams suffer ˜15-30% plastic deformation after compression test at 60% strain (FIG. 11). Cyclic loading shows that the foams remained intact even after 3000 cycles of compression and exhibited high damping coefficient (tan δ˜0.15), indicating that the foams have optimal energy absorption capabilities (FIG. 12).

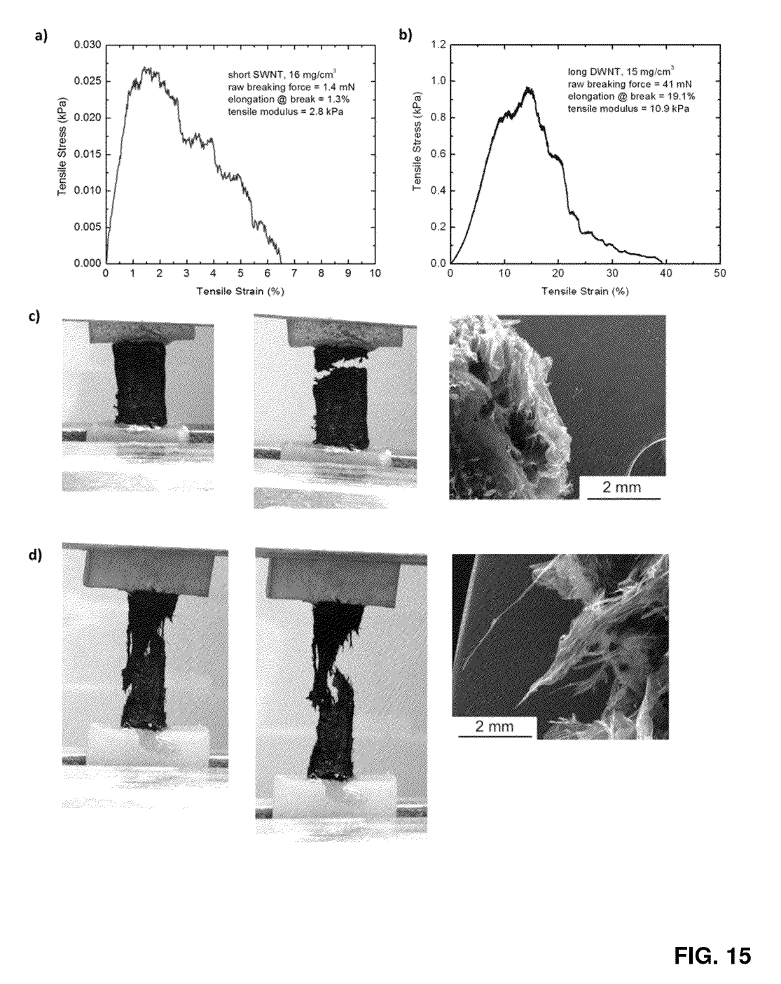

In addition to mechanical strength, the CNT foams have optimal electrical and thermal properties (FIGS. 3C-D). The long DWNT foams exceed the highest specific electrical conductivity of any cellular materials with densities below 100 mg/cm³, including recent CNT/graphene-based foams. The conductivity is stable (within ˜15% humidity-related fluctuations) for over 30 days (FIG. 15). Remarkably, these CNT foams have specific thermal conductivity comparable to metal foams, but are ten times lighter. The high conductivity arises from the higher quality of CNTs used (SWNTs or DWNTs compared to MWNTs in foams produced from CVD processes), as well as the ability to preserve CNT length and structural integrity by processing in true solvents.

The finding that foams from long DWNTs showed better electrical and thermal conductivities compared to short SWNT is consistent with published results on CNT fibers and films. The specific conductivity of long DWNT foams is ˜0.1 kSm²/kg, an order of magnitude lower than the best values reported for wet-spun long DWNT fibers (˜4 kSm²/kg). Without being bound by theory, Applicants envision that fibers consist of highly aligned CNTs, leading to better electrical and thermal interfacial transport.

The low density, mechanical robustness and conductivity of the foams are illustrated in FIGS. 3E-F. The images show that a long DWNT foam sample (density 15 mg/cm³) is easily supported by a feather, yet sustains a metal block over 1000 times heavier (FIG. 3E), and readily makes contact with a metal wire and conducts electricity to power a LED (FIG. 3F).

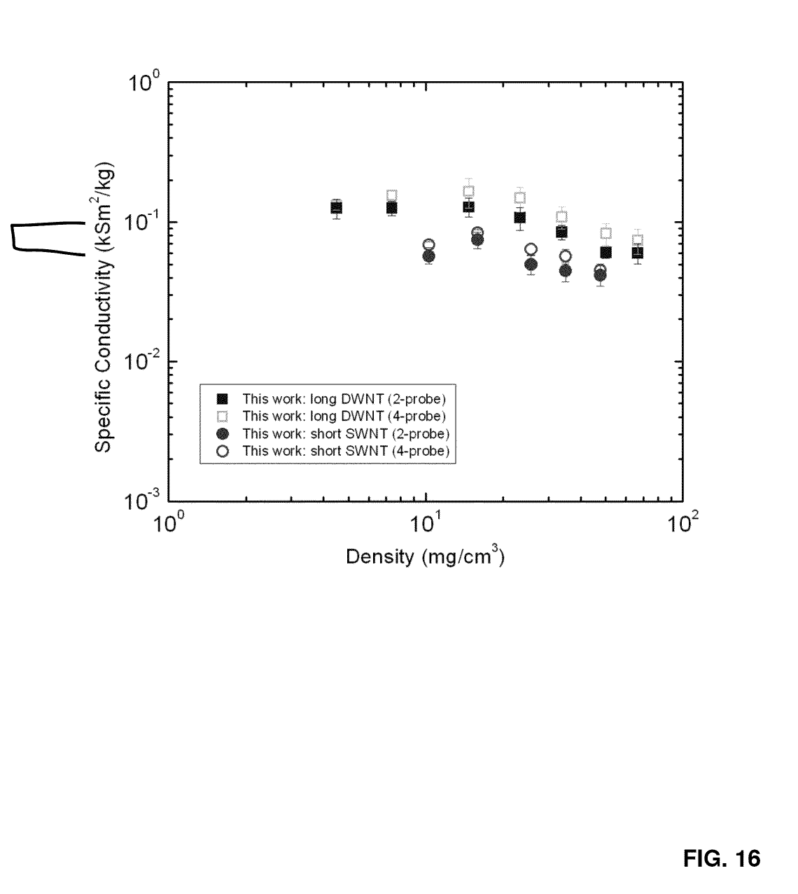

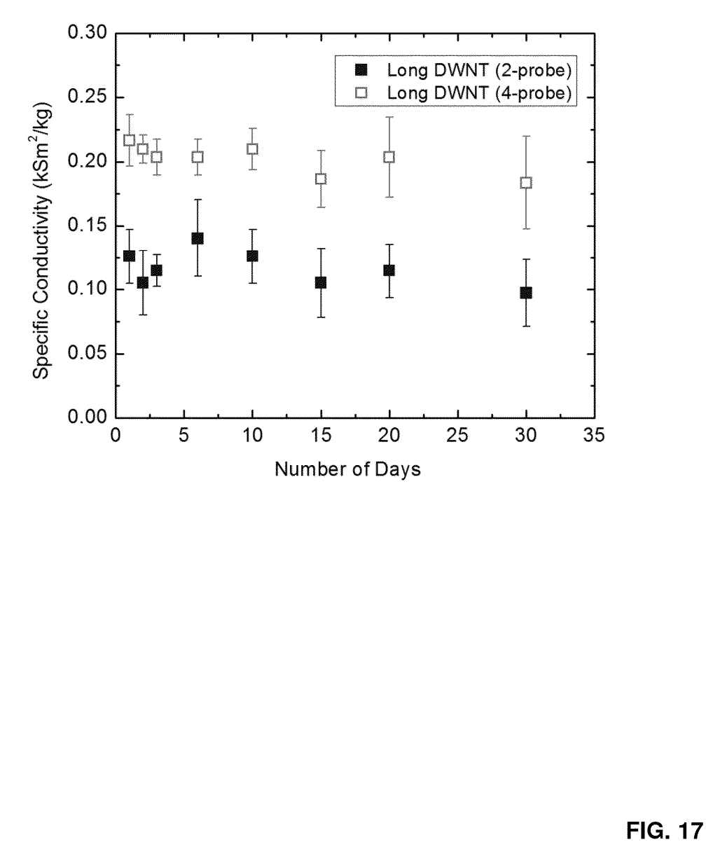

Because CSA does not damage the CNTs, the final foams remain highly hydrophobic, preferentially absorbing oil more than a hundred times their own weight (FIG. 16). The hierarchical structures consisting of thin entangled CNT sheets also allow these foams to act as particulate filters and become easily embedded with particles. For example, Applicants embedded CNT foams with magnetic cobalt nanoparticles through simple gravity filtration. The resulting foam exhibits magnetic behavior (FIG. 17) and is among the lightest magnetic foam materials in the literature (˜12-15 mg/cm³).

The porosity and permeability of the CNT foams open a new way to create CNT-polymer composite materials through direct polymer infiltration of the dry CNT foam samples. Applicants fabricated model composites using common polymers spanning high impact strength, rubber-like elastomeric characteristics, and energy damping capabilities: epoxy, polydimethylsiloxane (PDMS), and polyvinyl alcohol (PVA). Moreover, Applicants fabricated biocompatible composites of CNTs and polyethylene glycol (PEG) hydrogels because conductive CNT-based composites have potential use in biomedical applications.

Traditional CNT composites are usually fabricated by directly mixing CNTs with the polymer; this is laborious and requires either difficult mixing to sufficiently disperse CNTs into highly viscosity polymer melts, or days of waiting time to achieve controlled evaporation. Conversely, Applicants' fabrication process involves simply introducing the polymer solution drop-by-drop into the foam samples aided by vacuum, followed by heat curing for 2 hours or freeze-drying for 6 hours. These resulting composites are truly multi-functional materials, where the polymer matrix dominates the mechanical properties, but the composite retains the high conductivity of the original foam. For example, infiltration with epoxy increased the compressive modulus by three orders of magnitude, while infiltration with PDMS produced a composite with essentially ideally elastic behavior in compression. In all cases, the final composite retained over 50% of the conductivity of the CNT foam before infiltration. This is in agreement with the results reported for CNT/graphene-polymer composites also made by direct polymer infiltration, using foams produced via CVD. The electrical conductivity values in this work are among the highest reported to date and over 100 times higher than the best value reported for composites made by direct mixing of individual CNTs into a polymer.

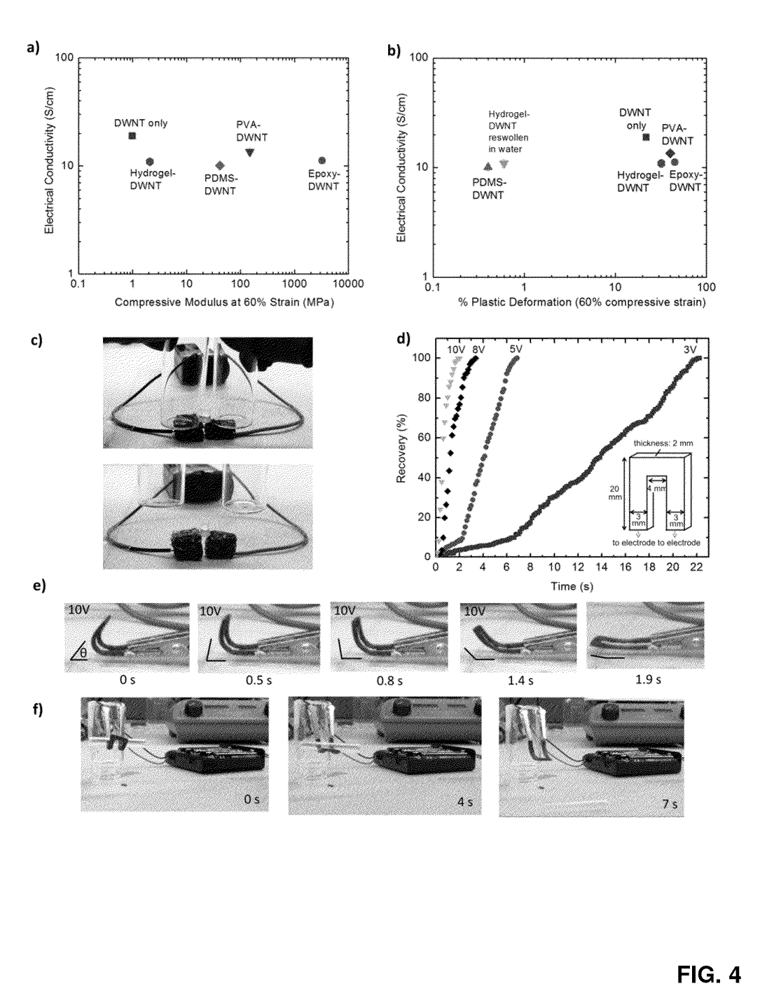

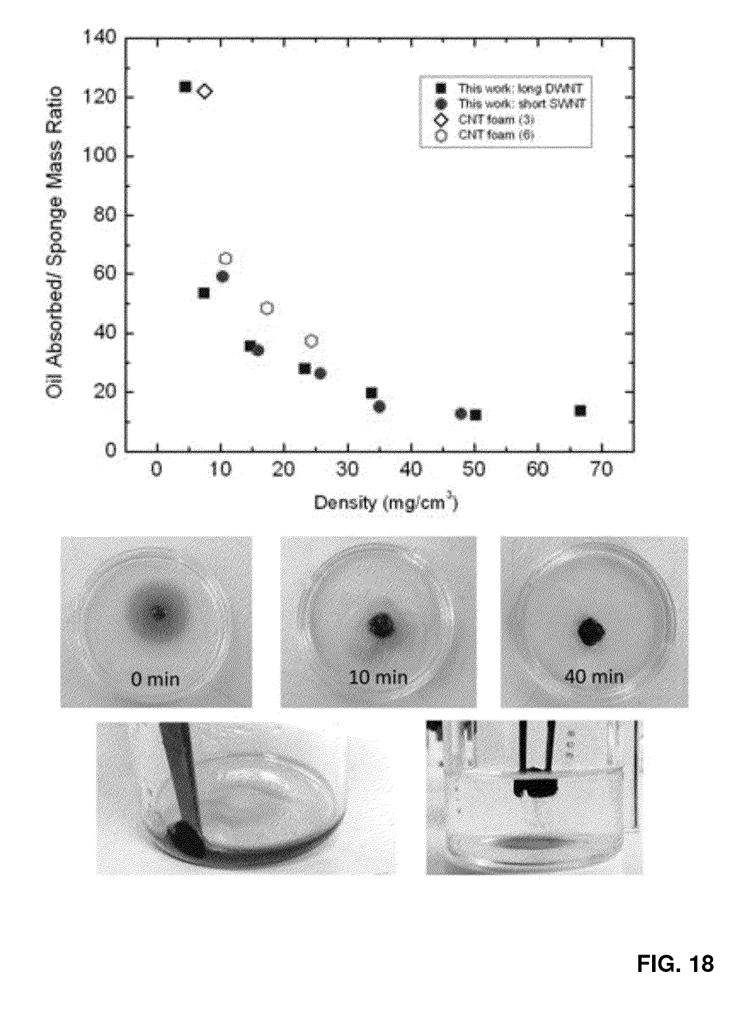

In sum, Applicants demonstrate in this Example the utility of polymer-CNT composites with high thermal and electrical conductivities by fabricating shape memory polymer (SMP)—CNT composites with unprecedented performance. SMP composites are “smart” materials that can retain indefinitely deformed shapes at temperatures below a critical transition temperature and morph back to their original, “memorized” shape when heated above the transition temperature. Electrically conductive SMPs can be heated by running electrical current (Joule heating). However, their practical uses are currently limited by their slow shape recovery speed and high required voltage (typically 30 seconds or longer at 10 to 40V for standard test fixtures). These drawbacks are due to the low electrical and thermal conductivity of the SMPs and the poor interfacial contract between the SMP matrix and the conductive fillers, resulting in inefficient conversion of electrical power into heat and uneven heat distribution within the sample. By infiltrating high surface area CNT foam with an epoxy-based SMP, Applicants created shape memory composites with a triggering voltage 5 times lower than the best value reported in literature (2V vs. 10V), as well as the fastest recovery speed reported to date (7.8 seconds at 5V and 1.9 seconds at 10V, compared to 18 seconds at 10V and 2 seconds at 20V), as shown in FIGS. 4C-D and FIG. 18. Because of the low triggering voltage, we can easily induce rapid shape change using a handheld AA battery pack (3V or 6V), as seen in FIG. 4F. This has not been possible with previously reported conductive SMPs since the minimum voltage required was 10V.

Applicants also demonstrated in this Example the fabrication of highly porous cellular solids (foams) composed of purely un-functionalized CNTs. The CNTs self-assemble into a continuous, percolated network of CNT bundles, yielding truly multi-functional foams with ultra-low density, high surface area, and optimal electrical, thermal, and mechanical properties. These foams greatly expand the material design space for low density, highly conductive materials, making them promising candidates as low density material for thermal management, shock absorbers with inherent “heat sinks” to prevent overheating, as well as conductive scaffolds for a wide range of applications such as catalysis, tissue engineering, electrodes for batteries, selective oil absorption, and EMI shielding. The fabrication method using CNT solutions is scalable and similar to the industrial injection molding process for polymers. In addition, these foams serve as excellent pre-formed networks to create highly conductive CNT-polymer composites through direct infiltration, such as electrically triggered shape memory materials with the best performance to date. Due to the scalability of the process and the high performance of the resulting foam structures, Applicants envision fabrication using acid solutions could be the method of choice for fabricating 3D carbon nanotube foams with applications beyond the laboratory.

### Example 1.1

### Foam Raman Spectra, XPS Spectra, and TGA Analysis

FIG. 5 shows the Raman spectra of the CNT foam samples fabricated from both long DWNT and short SWNT solutions in chlorosulfonic acid. Both spectra showed high G/D ratio comparable to the original raw CNTs, indicating that the fabrication process and dissolution in chlorosulfonic acid did not damage the CNTs.

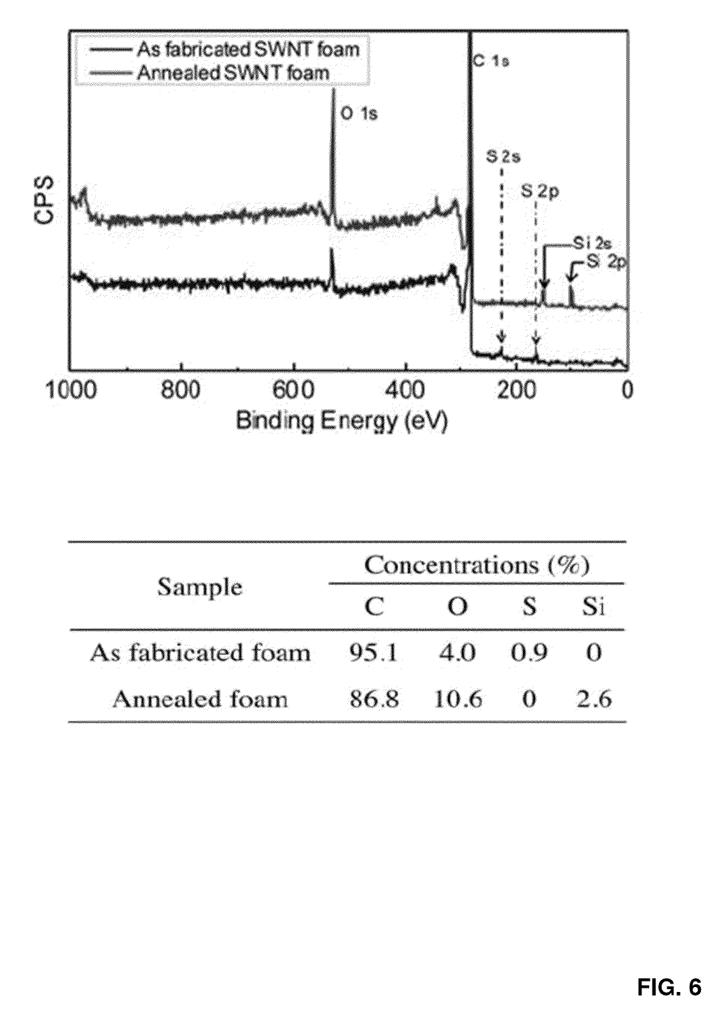

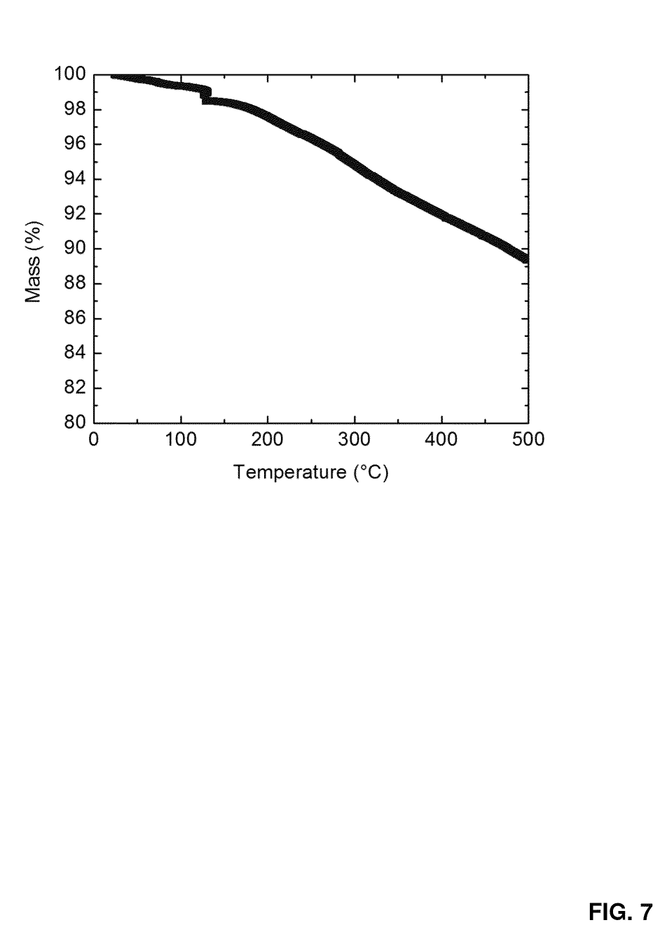

FIG. 6 shows the XPS spectra (survey scan) of the as-fabricated and annealed long DWNT foams, revealing that washing then freeze drying removes most of the acid components, although a small amount of sulfur remains in the sample (0.9 wt. %), which is likely intercalated inside the CNTs. Thermo gravimetric analysis (TGA) reveals that the as-fabricated foam sample contains ˜1-2 wt. % moisture and ˜9 wt. % residual acid (see FIG. 7). This sulfur contaminant can be removed by annealing the sample at 800° C. in an argon atmosphere, as seen in FIG. 6.

### Example 1.2

### CNT Solution in Chlorosulfonic Acid

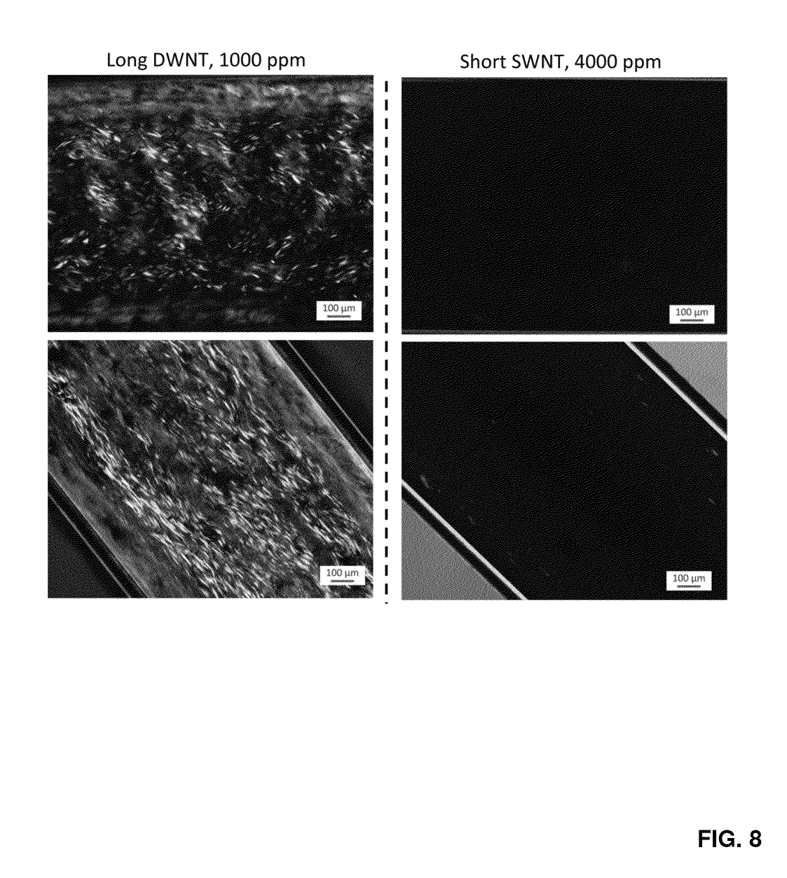

FIG. 8 shows optical microscopy images of CNT-CSA solutions in 1 mm thick glass capillaries under cross-polarized light, before the solutions were fabricated into foams. The concentrations shown here are the lowest limit at which foam samples could be fabricated for each type of CNT used (1000 ppm for the long DWNTs and 4000 ppm for the short SWNTs). The DWNT solution shows strong birefringence and high concentration of liquid crystalline domains. The SWNT solution shows only sparse liquid crystalline domains in an isotropic solution.

### Example 1.3

### Foam Morphology as Function of Density

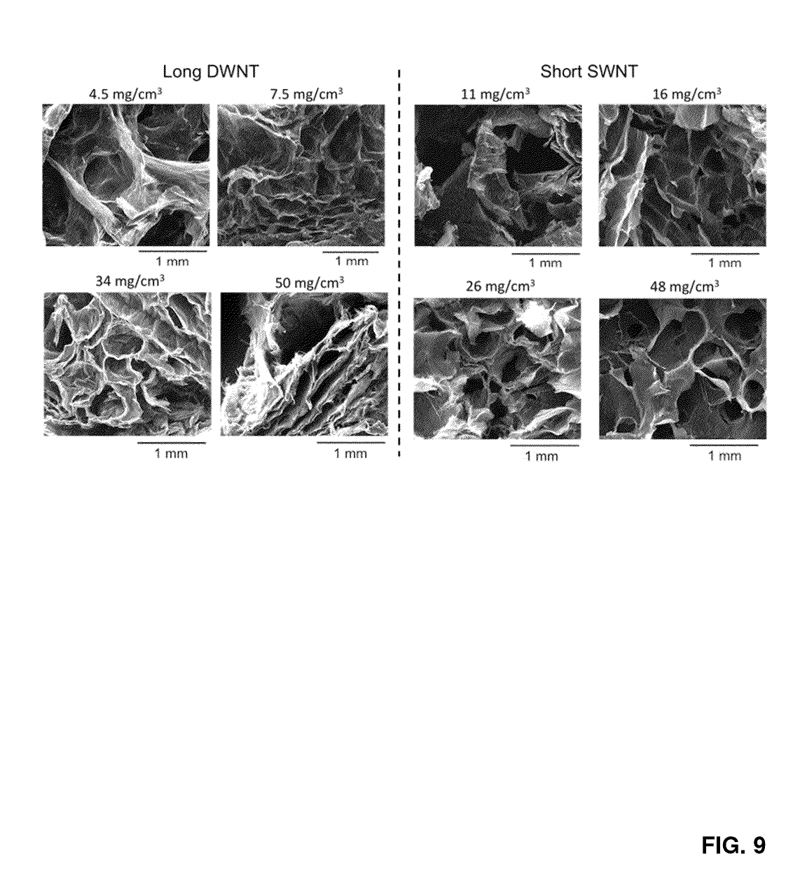

FIG. 9 shows SEM images of foam samples as a function of foam density (produced by varying the concentration of the starting CNT solution). Even at the lowest foam densities, the CNTs self-assemble into a percolated network of CNT sheets. As the density is increased, the number of folds of CNT sheets within the foam increases, leading to increased surface area. However, as the density continues to increase, the SEM images reveal that the number of CNT sheets within the foam no longer increases. Instead, the sheets become thicker.

FIG. 10 show the transmission electron microscopy (TEM) images of the DWNT and SWNT foams at comparable foam density, confirming the “web-like” structure of CNT bundles within the thin CNT sheets, forming the hierarchical 3D foam structure.

FIG. 11 shows SEM images of a piece of DWNT foam filled with PDMS, compared to the cross section of a piece of foam without polymer. Most of the voids have been filled with the polymer, but the fact that the SEM is able to still image the sample qualitatively confirms that the sample is conductive.

### Example 1.4

### Surface Area Characterizations

FIG. 12A shows the adsorption/desorption isotherms of both DWNT and SWNT foams at comparable foam density (15-16 mg/cm³). Both foams exhibit type IV isotherms, where a rapid rise in the isotherms near P/P₀=1 as well as hysteresis between the adsorption and desorption curves are observed. The hysteresis is a result of capillary condensation in the mesopores (2 nm-50 nm) and macropores (>50 nm pore diameter) of the sample. In addition, both isotherms exhibit a “rounded knee” at low pressures, where monolayer adsorption is taking place. This indicates the presence of micropores (<2 nm) in the samples. From the shapes of the isotherms, Applicants can qualitatively infer that the DWNT foam is more macroporous compared to the SWNT foam, due to both the more rapid rise in the isotherm at higher pressure and the less pronounced “knee” at lower pressures.

The isotherms are further analyzed using the Brunauer-Emmett-Teller (BET) theory, the t-method, and the Barrett-Joyner-Halenda (BJH) model, in order to quantify the micropore surface area, the total surface area, and the pore size distribution of the samples, as seen in FIGS. 12B-E. The SWNT foam has higher total surface area than the DWNT foam, but most of the extra surface area are trapped in micropores less than 2 nm. The DWNT foam contains more mesopores and macropores, and the pore size distribution is shifted toward larger pore diameters. For applications where accessible surface area and pore sizes of the CNT foams are important, such as energy storage and catalysis, the choice of CNT used to fabricate foams can therefore be an important design parameter.

### Example 1.5

### Mechanical Characterizations of CNT Foams

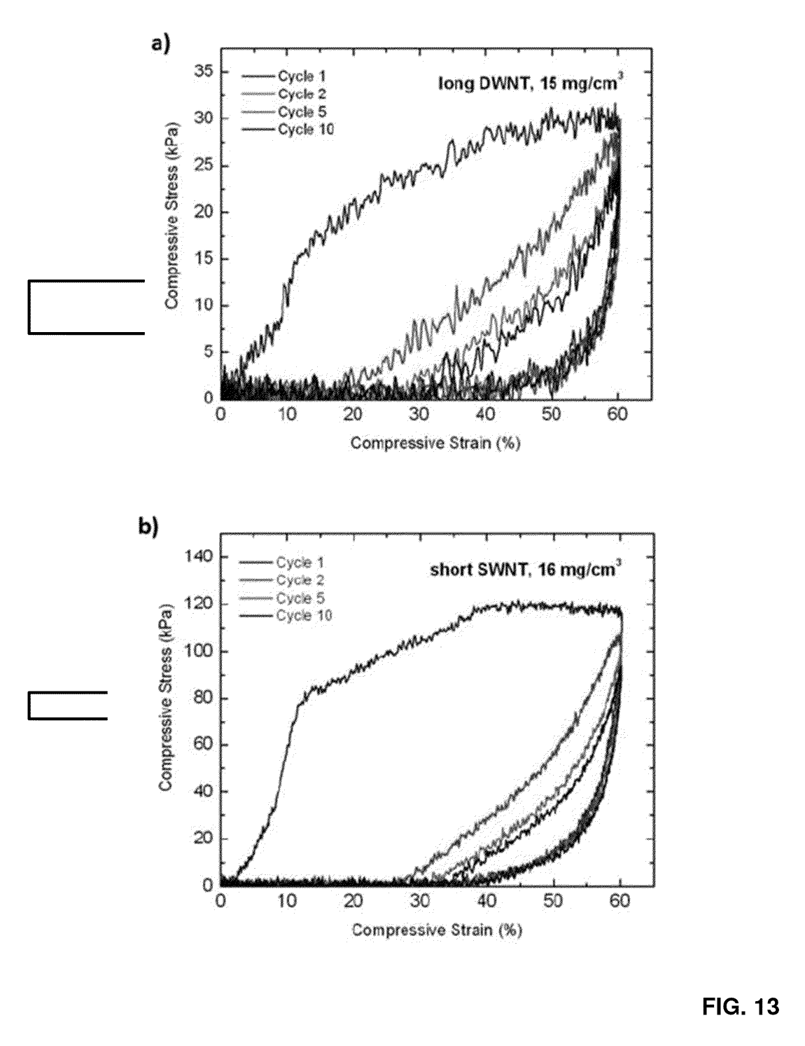

The CNT foam samples were subjected to compression tests at 60% strain over 10 cycles. FIG. 13 shows the stress-strain curves of a long DWNT foam sample and a short SWNT foam sample at similar density (15-16 mg/cm³), for cycles 1, 2, 5, and 10. Both foam types are viscoelastic materials showing a linear elasticity regime at low stress, commonly attributed to foam cell walls bending and cell face stretching, followed by a plateau region at high stress, corresponding to plastic yielding for viscoelastic foams. Upon decompression, both foams showed partial strain recovery, also characteristic of viscoelastic materials. The maximum stress response is significantly lower for the long DWNT foam (30 kPa) compared to the short SWNT foam (120 kPa). This indicates that the long DWNT foam is softer than the short SWNT foam sample, but suffered a lower degree of plastic deformation. The majority of plastic deformation resulted from the first cycle of compression.

The compressive modulus of elasticity of each foam sample was calculated using the Instron Wavematrix program, as the slope (tangent) of the straight line portion (linear elastic regime) of the stress-strain curve, as presented in the main manuscript. The modulus was calculated using the compression curve of the first cycle. The modulus of elasticity is some-times reported as the Young's modulus of the material, and the method for determining the values sometimes differ in different studies. Table 1 contains a summary of the method used to obtain the modulus values for each work in FIG. 3.

TABLE 1
provides a summary of methods used to obtain the modulus of elasticity (Young's modulus) for each
work in FIG. 3.

| Material | Reported modulus | Calculation method |
|---|---|---|
| CNT foam | Young's modulus | Highest slope stress strain curve |
| CNT foam | Young's modulus | Slope linear region stress strain curve |
| CNT-graphene foam | Elastic modulus | Slope linear region stress strain curve |
| CNT foam | Young's modulus | Nanoindentation ([13] Oliver et Parr) |
| Graphene foam | Young's modulus | Slope linear region stress strain curve |
| Aluminum foam | Modulus of elasticity | Not specified |
| Nickel foam | Young's modulus | Not specified |
| Metallic microlattice | Young's modulus | Slope linear region stress strain curve |
| Polyvinyl chloride foam | Compressive modulus | Slope linear region stress strain curve |
| Polyolefin foam | Young's modulus | Slope linear region stress strain curve |
| Silica aerogel | Young's modulus | Nanoindentation ([13] Oliver et Parr) |

The reference number [13] refers to C. Oliver et al., J. Mat. Res. 7, 1564-1583 (1992).

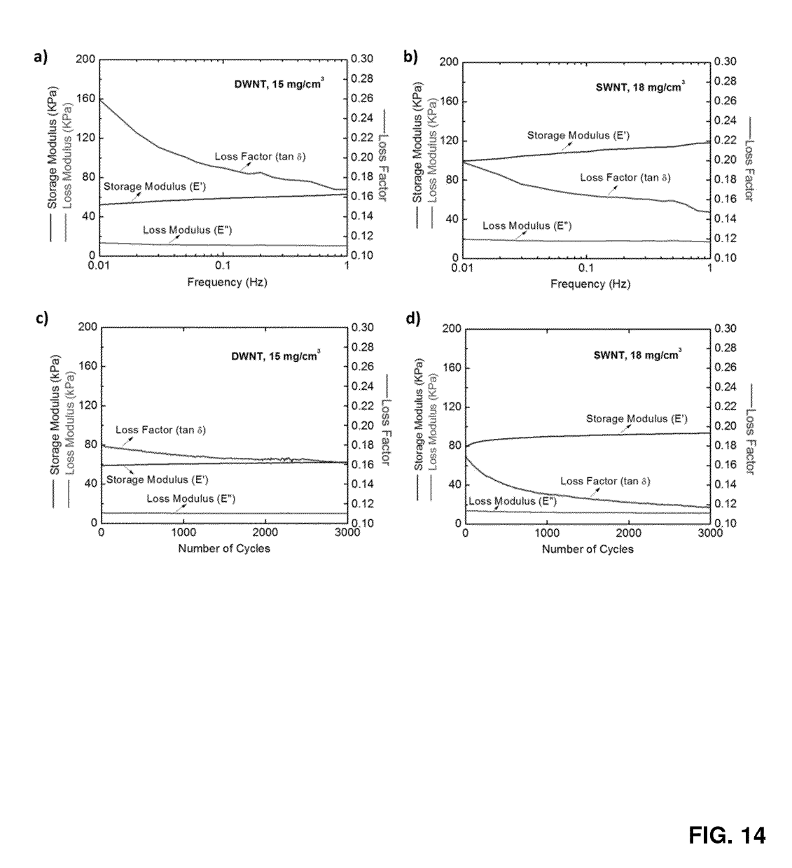

Because the foam samples are viscoelastic materials, dynamic mechanical analysis experiments (DMA) were performed to provide further information on the mechanical properties of the samples. FIG. 14 compares the storage modulus (E′), loss modulus (E″), and the damping coefficient tan δ (the ratio of the loss modulus to storage modulus), of short SWNT foams and long DWNT foams at comparable densities and porosities (15-18 mg/cm³ and 98-99% porosity), within the linear elastic regime. Both foams types exhibit high tan δ values (˜0.15), indicating optimal damping and energy absorption capabilities. The high tan δ of both foams are preserved, even after 3000 loading cycles. The slight increase of the storage modulus (E′) as function of increased number of cycles and frequency indicates stiffening of the foam samples.

To further understand the mechanical response of the foam samples, they were subjected to uniaxial tensile tests, as shown in FIGS. 15A-B. Because the foams are too soft to be installed onto the text fixtures using clamps, each ends of the foams were glued onto rectangular plastic pieces to form the “dogbone” shapes classically used for tensile experiments (see FIGS. 15C-D). At comparable density, both the SWNT and DWNT foams exhibit an initial linear elasticity regime in the stress-strain curve, corresponding to cell walls stretching. However, the DWNT foam experiences a clear plateau past the linear regime, followed by a second regime of increasing stress. This corresponds to plastic yielding due to cell wall alignment. In contrast, the SWNT foam sample fractured without exhibiting significant yielding, indicating that the SWNT foam is significantly more brittle under tension.

The raw breaking force for the DWNT foam is over an order of magnitude higher than the SWNT foam, as seen in FIG. 15. The plastic versus brittle fracture patterns for the two foam samples are also evident under SEM, by examining the broken ends of the samples after tensile failure, as seen in FIGS. 15C-D. While the short SWNT foams broke with a relatively uniform cross section, characteristic of a brittle fracture, the long DWNT foam shows long bundles of CNTs being pulled apart during the tensile experiment. Evidently, longer CNT length results in stronger bundles that contributes to enhanced tensile strength. Interestingly, previous research has found that some polymer foams made from rigid rod polymers are plastic in compression but brittle in tension, similar to the behavior of the SWNT foams. This has been attributed to the stress-concentrating effects of cracks, which cause failures rapidly under tension but are not as damaging under compression. The finding that SWNT foams behave more similarly to rigid rod polymer foams than DWNT foams is consistent with the fact that the SWNTs have smaller aspect ratios, and are therefore more rigid than the DWNTs.

### Example 1.6

### Electrical Characterizations of CNT Foams

Electrical properties of the CNT foams were measured using the two-probe method, where the ends of the rectangular sample are attached to a multimeter to measure the resistance. However, this method is subjected to the effect of additional contact resistance due to the electrodes and silver paint used to perform the measurements. Therefore, four-probe measurements were performed to validate the results of the two-probe measurements, as shown in FIG. 16. In all cases, the conductivity measured using the four-probe method are higher than the two-probe method (typically by a factor of ˜50%) due to the elimination of contact resistance. FIG. 17 shows the electrical stability of a DWNT foam sample at ˜11 mg/cm³. The conductivity can vary up to 15% depending on relative humidity, but remains stable over 30 days.

### Example 1.7

### Application of CNT Foams to Oil Absorption Capacity Measurements

Previous works on multi-walled CNT foams fabricated using CVD processes explored their application as oil absorbing materials. Because acid processing preserves the pristine sp² sidewalls of the CNTs, both the SWNT and DWNT foams are highly hydrophobic, unlike foams produced by most aqueous solution processing methods. FIG. 18 shows the absorption ratio (mass oil absorbed/mass foam) of foam samples from this work are comparable to values reported in literature for MWNT foams. In addition, due to their excellent mechanical integrity, the foams can be reused after squeezing out the oil.

### Example 1.8

### Application of CNT Foams for Nanoparticle Infiltration

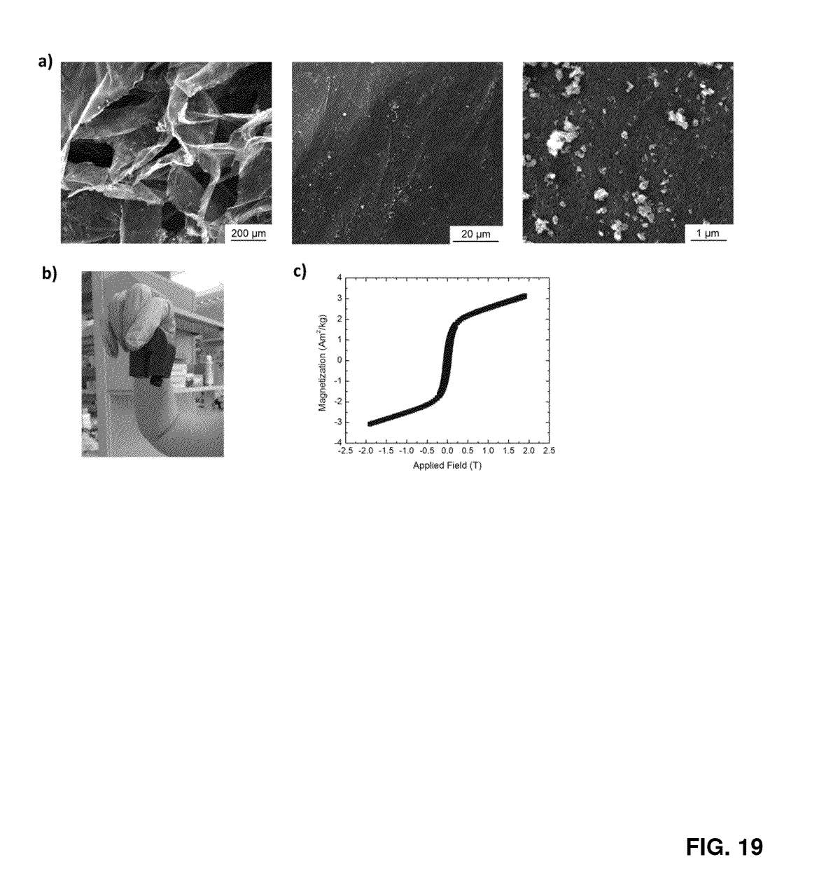

The hierarchical, membrane-like, yet permeable structure of the CNT foams also allows them to act as particulate filters, becoming embedded with nanoparticles simply by introducing the nanoparticle suspension drop-by-drop through gravity (see FIG. 19A). When magnetic cobalt nanoparticles are introduced, the CNT foam exhibits magnetic behavior while remaining lightweight, able to be picked up with a handheld magnet (see FIG. 19B). The hysteresis loop measured at room temperature shows that the CNT foam loaded with Co nanoparticles has a saturation magnetization of ˜2.5 emu/g, which is 100 times higher than cobalt-based carbon foams reported recently in Chen and Pan, although still about 10 times lower than iron-based carbon foams. With a density of ˜12-15 mg/cm³, these magnetic foams are among the lowest ever reported and more than 10 times lower in density than most magnetic foam materials, while still being highly electrically conductive.

### Example 1.9

### Application of CNT Foams as Shape Memory Composites

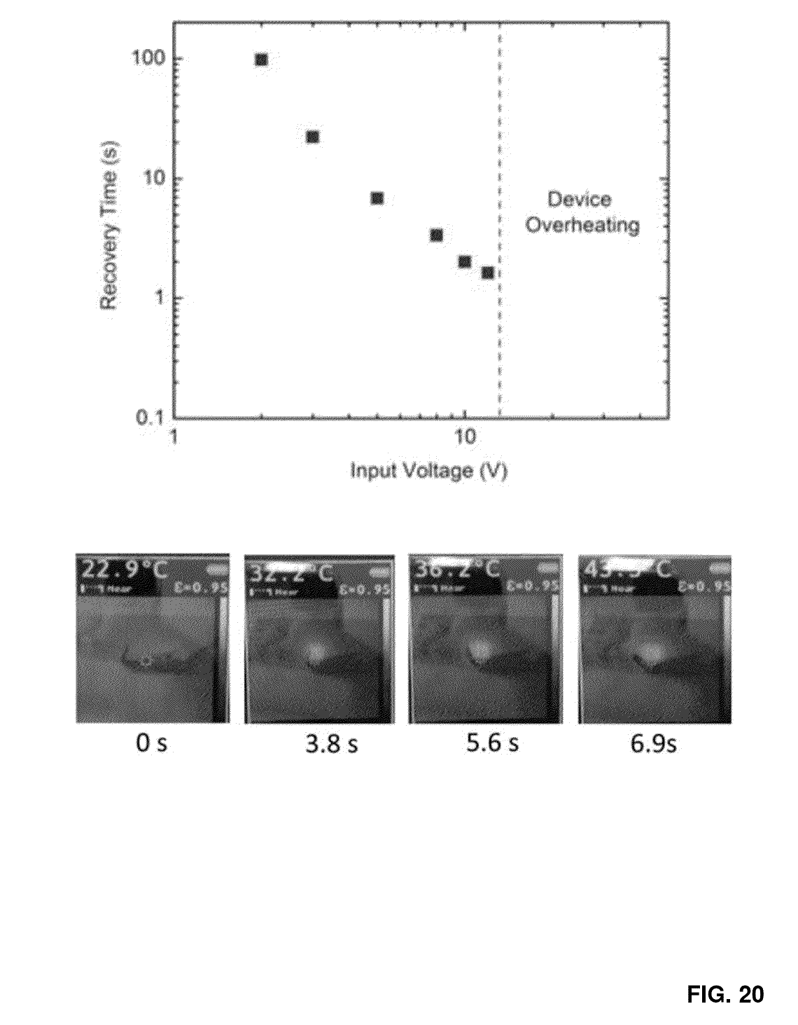

Shape memory-CNT composites are fabricated by directly infiltrating the DWNT foam with the shape memory epoxy polymer. FIG. 20 shows the electrically-triggered recovery time as a function of input voltage. As reported by previous works on shape memory composites, the input voltage has a significant impact on the recovery time. Increasing the voltage from 2V to 10V decreased the recovery time by 2 orders of magnitude. At voltage above 12V, the sample recovered its shape quickly but overheated, during which smoke generation is observed. Overheating is observed even at 10V if the input voltage is not turned off immediately upon shape recovery. Therefore, for this type of shape memory epoxy resin, the optimal operating window is between 3V and 10V, with a recovery time window between 23 seconds and 2 seconds. FIG. 20 also illustrates Joule heating of the sample using a AA battery pack with 4 batteries, as monitored with an infrared visual thermometer. The onset of shape change took place when the temperature of the sample reached ˜36° C. and finished when the temperature reached ˜61° C. For this particular experiment, the heating rate was found to be 3.1° C. per second.

### Example 1.10

### Materials and Methods

HiPco SWNT (batch 187.5) was produced at Rice University (Houston, Tex.) and purified according to literature methods (Nano Lett. 5, 163-168 (2004)). DWNT was purchased from Continental Carbon Nanotechnologies, Inc. (Houston, Tex., batch X647H), and used as received. TEM results in previous studies have shown that the estimated average length of the DWNTs is about 10 μm and the CNTs were mostly few-walled (single-, double-, or triple-walled with an average wall number of 2.25, and average external diameter of 2.4 nm). Chlorosulfonic acid (CSA, 99%) and all solvents were purchased from Sigma-Aldrich and used as received. Coagulation molds were constructed using 316 stain-less steel mesh sheets (Small Parts). Conductive silver paint was purchased from Alfa Aesar. Polyethylene (glycol) (PEG) diacrylate (MW=6000), photoinitiator acryloyl chloride, polyvinyl alcohol (molecular weight 146,000-186,000 g/ml, 98-99% hydrolyzed), bisphenol A diglycidyl ether, neopentyl glycol diglycidyl ether, and poly(propylene glycol) bis(2-aminopropyl ether) (average Mn ˜230) were purchased from Sigma-Aldrich. The PEG diacrylate was recrystallized twice from THF to remove inhibitor additives before use. All other chemicals were used as received.

PDMS resin and cross-linker (Sylgard® 184) were purchased from Dow Corning. Epoxy resin and cross-linker were purchased from Dow Corning. Epoxy resin and cross-linker (DOUBLE/BUBBLE® were purchased from Adhesives Hardman®.

### Example 1.11

### Synthesis of CNT Foams

The CNTs and CSA were mixed at the desired concentration using a high shear mixer (DAC 101 FV-K, Flack Tek inc.) for 20 minutes. The solution was injected using a glass pipette into stainless steel molds wrapped in teflon tape, then coagulated in a bath of ether undisturbed for 2 hours. Next, the sample was dipped in a bath of water to remove any residual acid, extracted from the mold, washed in a bath of isopropyl alcohol for 10 minutes, and finally immersed in a bath of DI water at 75° C. for 1 hour. The samples were flash-frozen in liquid nitrogen and freeze-dried at −45° C. overnight using a freeze dryer unit (Millrock Technology BT48). The dry foam samples were kept in an oven at 150° C. for 1 hr before bulk density measurements to eliminate any absorbed moisture from the environment. The foam density was calculated as the mass divided by volume, measured using a digital caliper. The porosity of the foams was calculated as follows: porosity=(1−ρfoam/ρCNT)*100%, where ρfoam is the density of the CNT foam sample, and ρcNT is the density of CNTs. The density of HiPco SWNT and CCNI DWNT have been reported previously as 1.4 mg/cm³ and 1.6 mg/cm³, respectively. For each data point on the density and porosity measurements, at least 10 samples were measured and the average value was reported.

### Example 1.12

### Preparation of CNT-Polymer Composites Through Direct Infiltration

The dry foam sample was set on a stage connected to vacuum, and the polymeric fluid was applied drop-by-drop to ensure the foam is fully infiltrated. The PDMS polymer consisted of the resin and curing agent at a concentration of 10:1 by weight, and the epoxy polymer consisted of the resin and cross-linker at a concentration of 1:1 by volume. After the infiltration process was complete, the foam was placed in an oven at 100° C. overnight to allow curing to take place. For PVA-infiltrated foams, a 5 wt. % solution of PVA in DI water was allowed to mix for 24 hours at 90° C., followed by immersion of the dry CNT foam in the solution at 90° C. for 15 minutes. Next, the infiltrated foams were flash-frozen with liquid nitrogen and freeze-dried as reported above. For CNT foam/PEG-DA hydrogel composites, the photoinitiator and recrystallized PEG-DA were dissolved in water at a ratio of 1:100:400 by weight, then the dry foam samples were immersed in the solution at room temperature for 15 minutes. This was followed by curing in a UV chamber (ELC-500, Electro-lite Corporation) for 10 minutes.

### Example 1.13

### Microscopy

The CNT foam morphology was characterized using a scanning electron microscope (FEI quanta 400 ESEM). Each foam sample was cut in half carefully using a sharp razor or scissors and the cross section was imaged. The TEM specimens were prepared by a FEI Novae ion beam (FIB) microscope. In order to protect the specimen during ion milling, a protective 2-μm platinum cap was deposited on the specimen and two trenches (30 μm×30 μm×15 μm each) on either sides of the Pt cap were machined out. Next, the 30 μm×30 μm×15 μm Pt cap-protected sample was extracted by an Omniprobe 300® manipulator and attached to a Cu grid.

### Example 1.14

### CNT-CSA Solution Imaging

The solutions were imaged in rectangular glass capillaries (0.10×1.00 mm) with an optical microscope (Zeiss Axioplan) fitted with crossed polarizing filters. The glass capillaries were filled by capillary forces and flame-sealed to avoid reaction with moisture.

### Example 1.15

### XPS and Raman Spectroscopy

Surface analysis of the DWNT foams by X-ray photoelectron spectroscopy (XPS) was performed using a Surface Science Instruments (SSI) M-probe XPS equipped with an Al Kα X-ray source operated at 10 kV and a base pressure of approximately 4.0×10⁻⁷ Pa. Spectra were recorded at a fixed take-off angle of 50°, and analyzed using the CASA XPS software, which has built-in corrections for spectrometer sensitivity factors for the SSI M-probe XPS. Raman spectroscopy was carried out using a Renishaw in Via confocal micro-Raman spectrometer with a 50× objective and using a 514.5 nm laser as the excitation source. The maxi-mum power at the sample level was 0.17 mW during the Raman analysis. A Gaussian-Lorentzian mixed profile was used to fit the Raman peaks for the disorder induced D band (˜1335 cm⁻¹ for the SWNT foam and 1345 cm⁻¹ for the DWNT foam) and G band (1587 cm⁻¹ for the SWNT foam and 1589 cm⁻¹ for the DWNT foam). The intensity ratio of the D band over that of the G band (I_{D}/I_{G}) was very low for both samples (very high G/D ratios). The exact calculated values of I_{D}/I_{G} are 0.04 for the SWNT foam and 0.02 for the DWNT foam (G/D ratio of 21 and 69, respectively). Interestingly, the Raman spectra corresponding to the SWNT foams exhibits a shoulder in the G band, located at ca. 1556 cm⁻¹. That shoulder has been associated to SWNTs that exhibit metallic behavior. A sp² characteristic feature arising from a second order two-phonon process (G or 2D band) was observed at 2677 cm⁻¹ for the SWNT case. For the DWNT foam, the G band has been identified at 2682 cm⁻¹. Radial breathing modes (RBMs) have been also identified in both the materials. For the SWNT foams, the RBMs are seen at 247 cm⁻¹, 266 cm⁻¹, and 319 cm⁻¹ and for DWNT foams, the RBMs are seen at 158 cm⁻¹, 209 cm⁻¹, and 264 cm⁻¹.

### Example 1.16

### TGA Analysis

Thermogravimetric analysis (TGA) of the foam sample was performed in an inert Argon atmosphere using a TA Instrument Q-600 simultaneous TGA/DSC apparatus. The starting sample weight is 17.9 mg. The sample was heated from room temperature to 130° C., then held at 130° C. for 30 minutes to estimate the mass loss due to moisture, then heated to 500° C. to estimate the mass loss due to residual sulfur in the sample.

### Example 1.17

### Nitrogen Adsorption Experiments

The nitrogen absorption isotherms were obtained using the Quantachrome Autosorb-3b surface analyzer. The samples were degassed and heated at 200° C. for 12 hours prior to the measurements to remove all traces of moisture. For each sample, 40 points each were taken for the adsorption and desorption curves. The data analysis, including the BET surface area, t-plot micropore area, and BJH pore size distribution, were performed using the Quantachrome Autosorb software.

### Example 1.18

### Mechanical Characterizations

Compression tests at 60% strain (compression frequency of 0.5 Hz) were performed using an Instron (Electropuls E3000) instrument and Wavematrix Software. For cyclic tests, the dynamic properties (storage modulus, loss modulus and loss factor) were measured by Q800 (TA Instruments) at multi-frequency mode with 1% strain amplitudes and 0.15 N preload at frequencies ranging from 0.01 Hz to 1 Hz. The cyclic tests were also performed in the multi-frequency mode of Q800 with fixed frequency at 1 Hz with constant preload. The sampling rate is around 1 point per 5 cycles. Tensile test stress-strain curves for the foam samples were obtained on an Instron model 1000 testing frame with a 5 kg load cell, under uniaxial tension. The foam samples were fabricated as rectangular specimens (approximately 2 cm×1 cm×0.5 cm) and attached to two pieces of epoxy rectangular blocks, forming “dog-bone” shaped samples. The raw measurements of force obtained from these instruments were converted into stress values by dividing by the cross sectional area of the sample, measured using a digital caliper.

### Example 1.19

### Electrical Conductivity

A layer of silver paint and silver wire were uniformly attached onto the ends of a rectangular sample (1 cm×1 cm×2 cm), and for the two-probe measurements, the resistance reading was recorded by connecting the silver wires to a multimeter (Fluke 891V) using alligator clamps. The contact resistance between the two clamps was measured and subtracted (0.15Ω). For composite samples, the silver paste and wire were applied to the foam samples prior to the infiltration of polymer to ensure proper electrical contact. For four-probe measurements, the electrodes were attached to the ends of the rectangular sample, supplying the measurement current of 50 mA, while the voltage drop across the sample was measured with a second set of electrodes, thus isolating the sample resistance from the electrode contact resistance. The voltage drop was measured using the multimeter over a distance of 1 cm.

### Example 1.20

### Thermal Conductivity

The thermal diffusivity, λ, of the foam samples was measured with laser-flash method (LFM), using a Netzsch Laser flash apparatus under argon purge. The samples are formed into 8 mm×8 mm×3 mm specimens. The laser flash (or heat pulse) technique consists of applying a short duration (<1 ms) heat pulse to one face of a parallel sided sample and monitoring the temperature rise on the opposite face as a function of time. This temperature rise is measured with an infrared detector. A laser is used to provide the heat pulse. Thermal diffusivity can then be calculated as λ=ωL²/πt_{1/2}, where ω is a constant, L is the thickness of the specimen and t_{1/2} is the time for the rear surface temperature to reach half its maximum value. The measurement for the thermal diffusivity was performed at 25° C. The laser voltage used for the measurements was 2882 volts and the acquisition time was 500 ms. The heat capacity (Cₚ) of the samples at 25° C. was measured using a differential scanning calorimeter (DSC Q20, TA Instruments), from 10° C. to 50° C., at a heating rate of 5° C./min. The average heat capacity was found to be 1.1 J/gK. From the thermal diffusivity data and the heat capacity (average over two samples), the thermal conductivity was calculated using the relationship κ=ρλCₚ, where ρ is the sample density.

### Example 1.21

### Oil Absorption Capacity Measurements

The absorption capacity of the samples was measured using pump oil (Fischer Scientific, density=0.87 g/ml). Dry foam samples were submerged in a bath of pump oil for 15 minutes. The ratio of foam weight after and before adsorption was calculated. For the qualitative photographs, the pump oil was dyed green with propylene glycol dye (AmeriColor).

### Example 1.22

### Nanoparticle infiltration measurements

Dried cobalt nanoparticles (J. Magn. Magn. Mater. 321, 1351-1355 (2009)) were sonicated for 1 minute in a 1 wt. % sodium dodecyl sulfate (SDS) surfactant solution at a concentration of 5 mg/ml. The nanoparticle solution was then delivered to foam samples drop-by-drop by gravity, then frozen with liquid nitrogen and freeze-dried overnight. The hysteresis loop of CNT foam loaded with cobalt nanoparticles was measured at room temperature using a vibrating sample magnetomoter (VSM) at NIST.

### Example 1.23

### CNT-Shape Memory Epoxy Composite Fabrication and Testing

The shape memory epoxy resin was prepared according to Xie et al., Polymer 50, 1852-1856 (2009). The three chemicals, bisphenol A diglycidyl ether, neopentyl glycol diglycidyl ether, and poly(propylene glycol) bis(2-aminopropyl ether), were mixed at a molar ratio of 1:1:1. The bisphenol A diglycidyl ether was first weighed and melted at 90° C. in an oil bath prior to mixing. The CNT foam was pre-cut to the “U” shape required for electrical triggering experiments and immersed in the mixed polymer for 10 minutes, followed by curing in an oven at 100° C. for 1 hour. Prior to immersion in the polymer, the surface of the ends of the CNT foam are protected with copper tape or silver paste to minimize the contact resistance between the sample and the electrodes. For electrically-actuated shape recovery experiments, the U-shaped composite sample was connected to a DC power supply (B&K Precision 1786B) using alligator clamps. The sample was placed in an oven at ˜100° C. for 10 seconds and deformed to a deformation angle of ˜135° (see main manuscript for details), then connected to the power supply. Each shape recovery experiment was recorded continuously using a high-speed digital video camera (Casio EX-FH25) at 120 frames per second. Each frame was analyzed using the Photron FASTCAM Viewer and ImageJ to obtain the deformation angle as a function of time. The % recovery was calculated according to Luo and Mather, as follows: % recovery=(θᵢ−θ(t))/(θᵢ−θₑ)*100%, where θᵢ is the initial deformation angle (˜135°), and θ(t) is the deformation angle at time t, and θₑ is the deformation angle at the final/equilibrium state of the composite (θₑ=0 for this setup. Infrared images were captured using an infrared visual thermometer (Fluke VT02).

### Example 2

### Facile Fabrication of Highly Conductive Carbon Nanotube Solid Foams and Composites through Scalable Solution Processing

In this Example, porous foam-like structures consisting of only carbon nanotubes (CNTs) were fabricated by coagulating pristine CNT solutions from chlorosulfonic acid (CSA) in accordance with the methods outlined in Example 1. In particular, high-quality single and double-walled carbon nanotubes were dissolved in CSA and coagulated, as previously described.

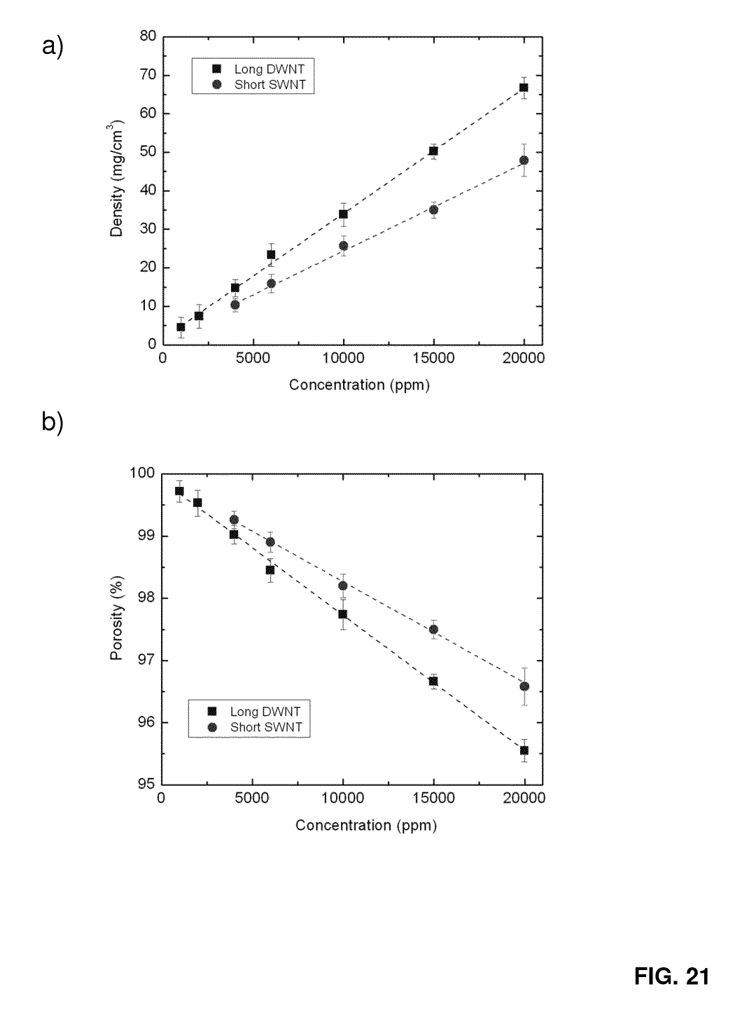

As shown in FIG. 21, the bulk density (FIG. 21A) and porosity (FIG. 21B) of the fabricated foams samples can be controlled by varying the initial CNT solution concentration. For instance, the density can be varied from ˜4.5 mg/cm³ to 67 mg/cm³, corresponding to a porosity range of 99.5% to 95.5%. Below a concentration of 1000 ppm for the long DWNT and 4000 ppm for the short SWNT, the foam samples were fragile and easily broken during experiments. The use of CSA as the CNT solvent enabled the achievement of high solution concentrations (>1000 ppm), which is not possible to achieve through sonication in aqueous systems without shortening the nanotubes. The surface area of the samples was in the range of 400-800 m²/g. Because of the dense sheets of CNT formed within the foam structure consist of strong, entangled CNT bundles, the final foam materials are mechanically robust.

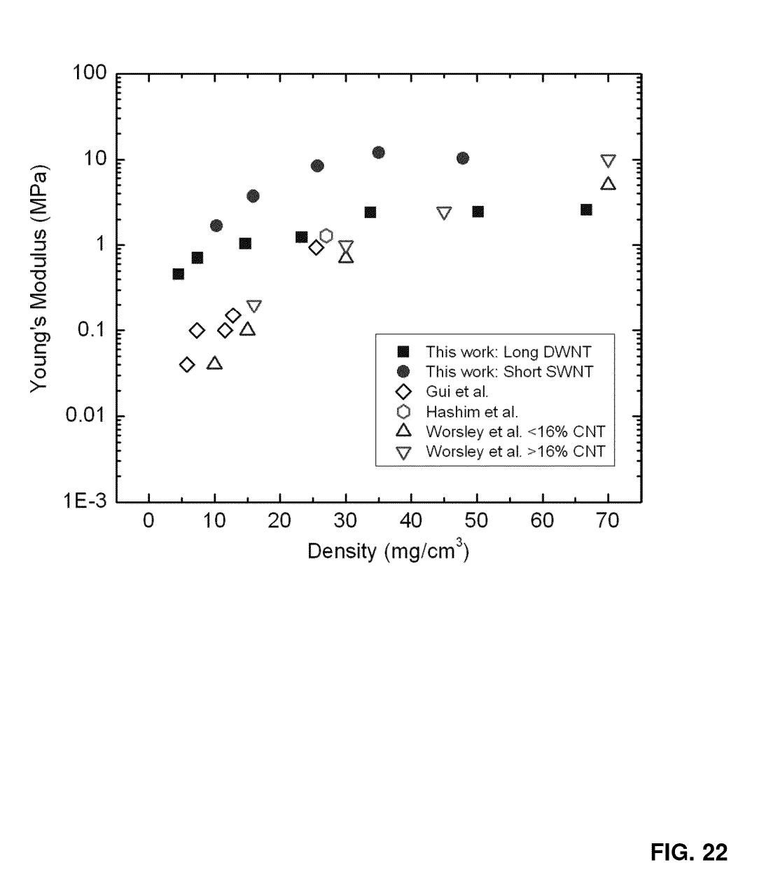

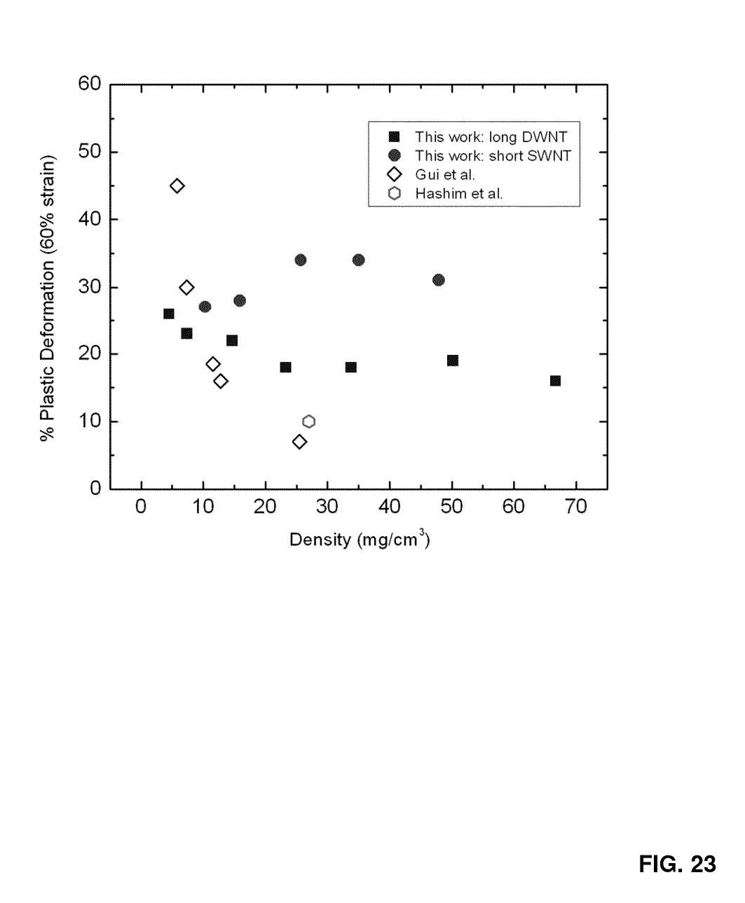

FIGS. 22-23 show the average Young's modulus and percent plastic deformation of the samples as a function of bulk density, under a compression test at 60% strain. Properties of CNT foams from previous works in literature are also shown for comparison. The Young's moduli for the samples in this work are among the highest reported to date, especially in the bulk density range of 30 mg/cm³ or below. The short SWNT foams showed higher Young's moduli at comparable bulk density compared to the long DWNT samples, but suffered larger degree of plastic deformation after compression. In contrast, foams consisting of long DWNTs are softer and more elastic. The CNT foams in this work showed lower plastic deformation compared to literature values at very low density (<10 mg/cm³). However, the percent plastic deformation did not decrease as the density increased. Without being bound by theory, this is possibly due to the macroporous structure of the foams. The degree of plastic deformation can potentially be improved by introducing covalent crosslinks between CNTs. Previous works have shown that introduction of covalent crosslinking points (through a sol-gel process or coating with polymer, followed by pyrolysis to convert the crosslinking agents into carbon) decreased the extent of plastic deformation.

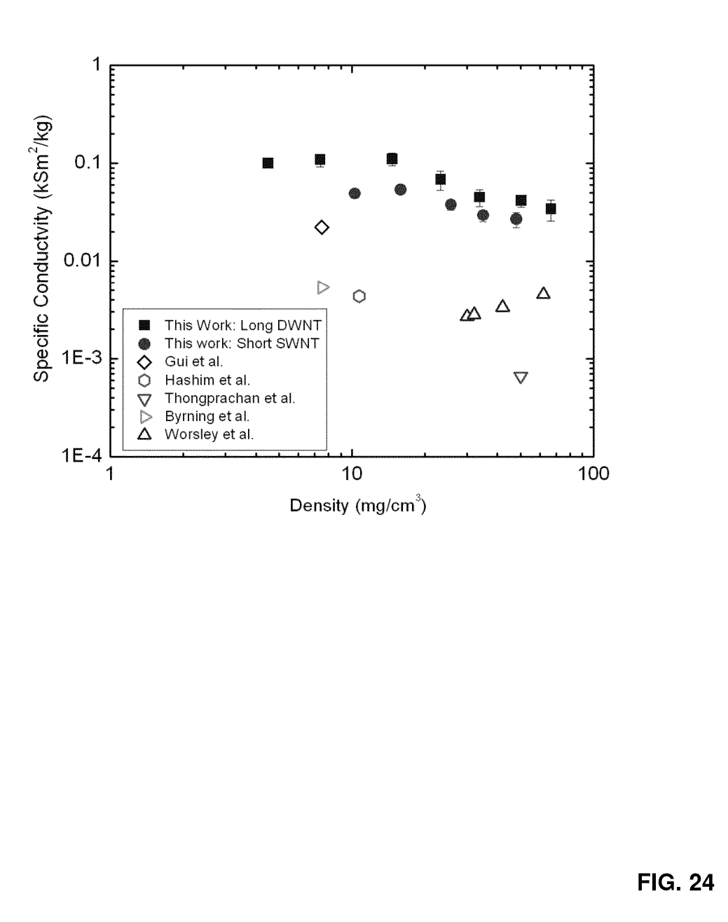

The foams in this work also showed optimal electrical properties compared to previously reported values, as shown in FIG. 24. With out being bound by theory, this could be due to the higher quality of CNT used (single or double-walled CNTs compared to multi-walled CNTs from foam samples produced through CVD processes) as well as the fact that dissolving in CSA preserved the lengths of the nanotubes compared to other solution processing techniques. The finding that long DWNTs showed better electrical properties compared to short SWNT is consistent with published results on CNT fibers and films. Furthermore, the best specific conductivity reported for the CNT foams in this work is ˜0.1 kSm²/kg, which is still an order of magnitude lower than the best values reported for wet-spun CNT fibers (˜4 kSm²/kg).

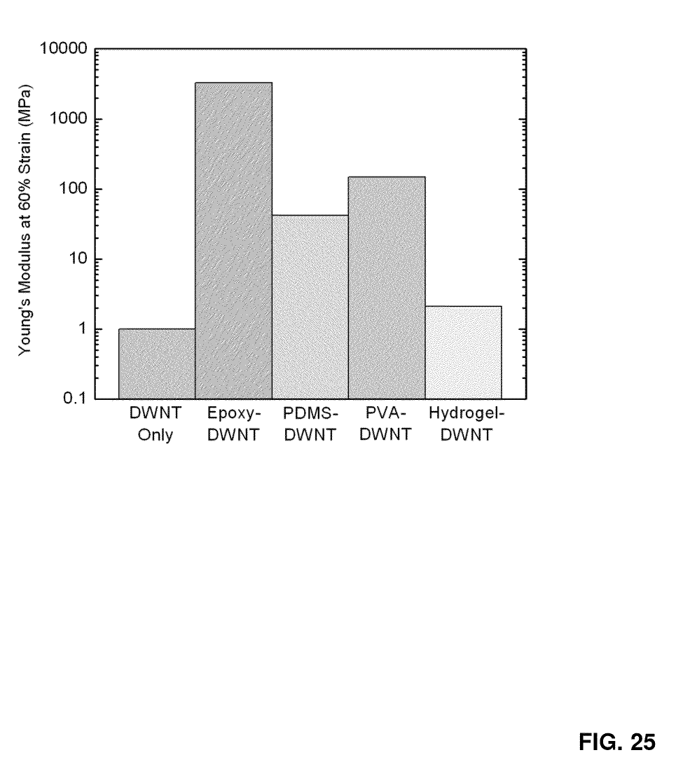

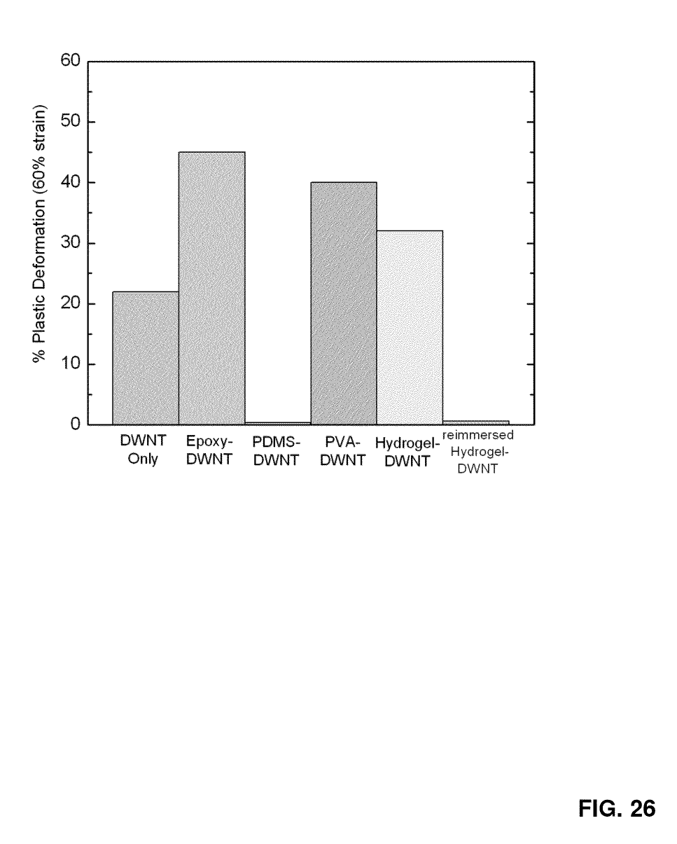

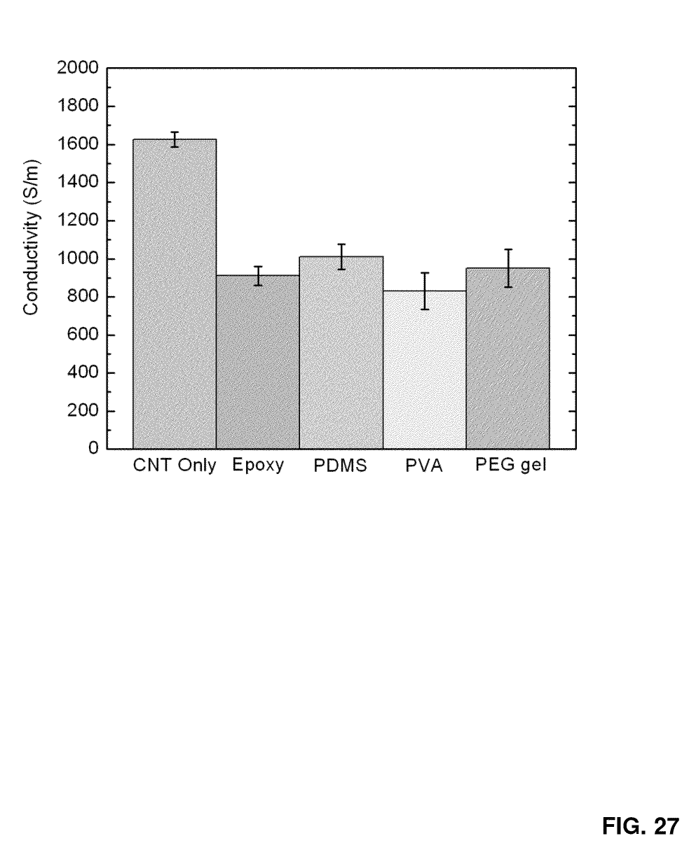

Applicants also used the CNT foams of the present disclosure to create composite materials through direct polymer infiltration. Some common polymers were chosen to fabricate model composites: epoxy, polydimethylsiloxane (PDMS), and polyvinyl alcohol (PVA). In addition, because conductive CNT-based composites have potential use in biomedical applications, a biocompatible composite of CNT and polyethylene glycol (PEG) hydrogel was also fabricated. The polymer liquid was introduced drop-by-drop into the foam samples, followed by curing in the oven (epoxy and PDMS), curing in a UV chamber (PEG hydrogel), or lyophilization (PVA). The mechanical properties of the resulting composites were dominated by the polymer matrix, but the composites remained conductive, as shown in FIGS. 25-27. For example, the epoxy-CNT composite increased the Young's modulus of the original CNT foam by three orders of magnitude, while infiltration with PDMS eliminated essentially any plastic deformation upon compression.

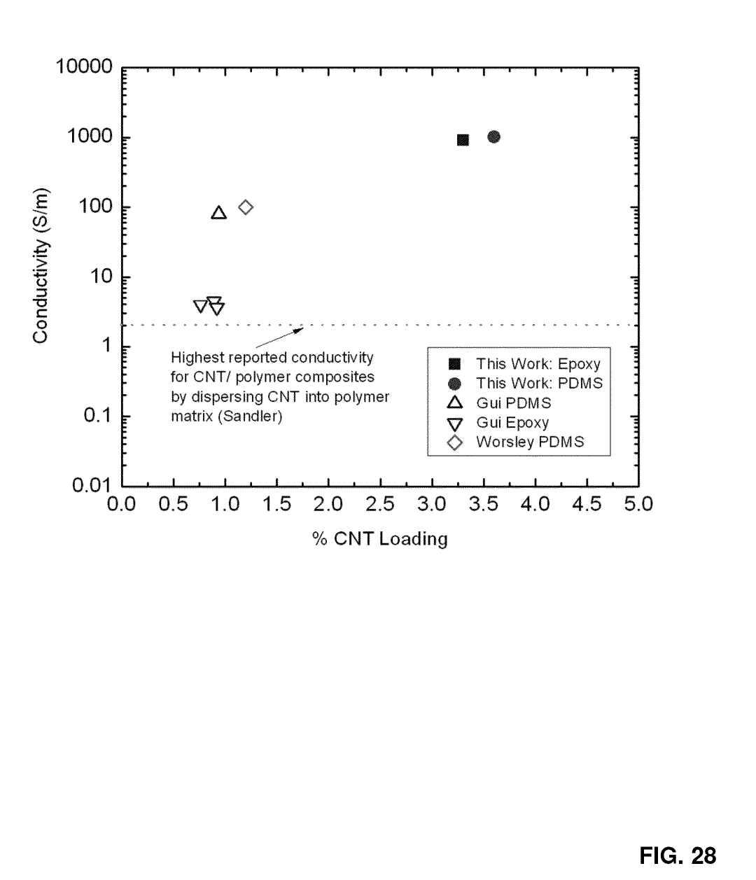

In all cases, the final composite retained over 50% of the conductivity of the original foam. This is in agreement with the previously reported results for CNT-polymer composites also made by direct polymer infiltration, using multi-walled CNT foams produced in a chemical vapor deposition (CVD) system. Furthermore, the composite materials show competitive electrical conductivity compared to composites made by mixing individual CNTs into a polymer matrix, where up to 5 orders of magnitude drops in conductivity have been reported. FIG. 28 compares conductivity values of CNT-polymer composites (either epoxy or PDMS) in this work and values reported in literature. Composites fabricated using direct infiltration have significantly higher conductivity values compared to composites made by mixing CNT into the polymer matrix. Furthermore, conductivity is increased with CNT loading. The composites reported in this work have achieved the highest conductivity to date, close to 3 order of magnitude higher than the best value reported for composites made through CNT mixing into the polymer matrix (Sandler et al., Polymer, 2003, 44, 5893-5899).

Based on the measured density of the composites compared to the density of pure epoxy and PDMS samples, the composite samples fabricated in this work are approximately 90% (±3%) infiltrated. Without being bound by theory, this suggests that the polymer precursors may be unable to completely infiltrate in between the CNT bundles forming the dense sheets of the foams, and/or that despite the macroporous structure of the foams, the structure may not be completely open-celled and some of the pore volume were not accessed by the filtration process.

### Example 3

### Graphene-Based Foams

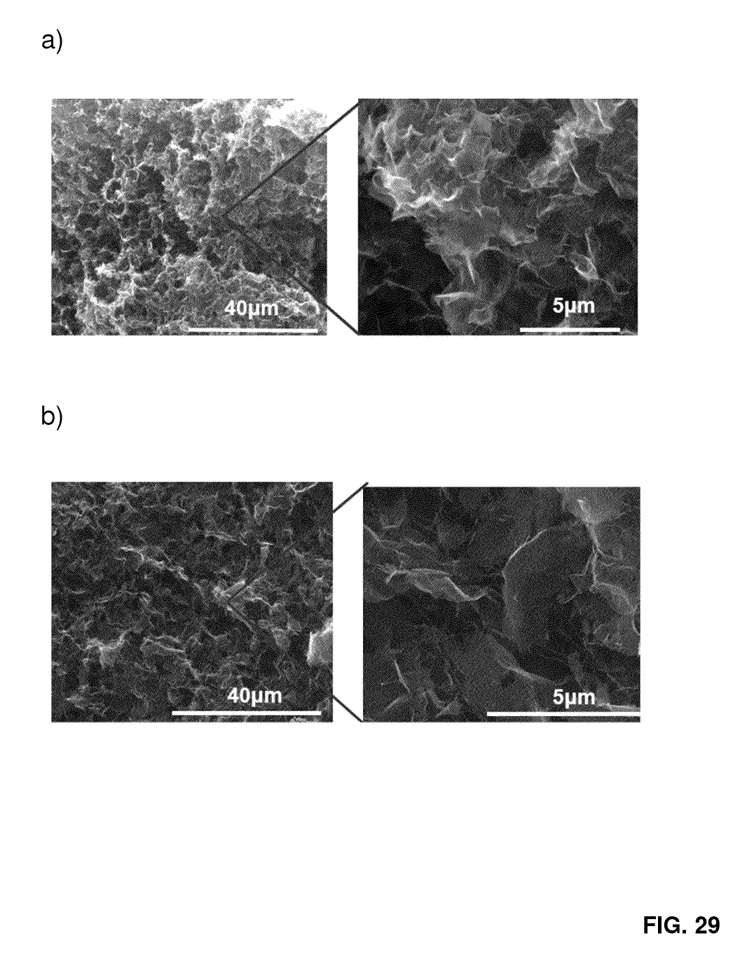

This Example demonstrates that graphene can be used as a carbon source in the carbon foams of the present disclosure. For instance, FIG. 29A shows the morphology of graphene-based foams that were made in accordance with the methods of the present disclosure. The graphene-based foams in FIG. 29A contain 100% graphene at 1.1 wt. % carbon and have a density of about 38 mg/cm³.

Applicants have observed the 100% graphene foams may be fragile in some instances. However, Applicants have observed that the addition of small amounts of CNTs as carbon sources during the formation of the graphene foams greatly enhances their structural integrity.

The morphologies of some CNT-graphene hybrid foams are shown in FIG. 29B, where the foams have 5%-95% CNT-graphene, 0.5 wt. % carbon, and a density of about 21.5 mg/cm³. Furthermore, the bridging of graphene flakes by CNTs can be observed in FIG. 29B.

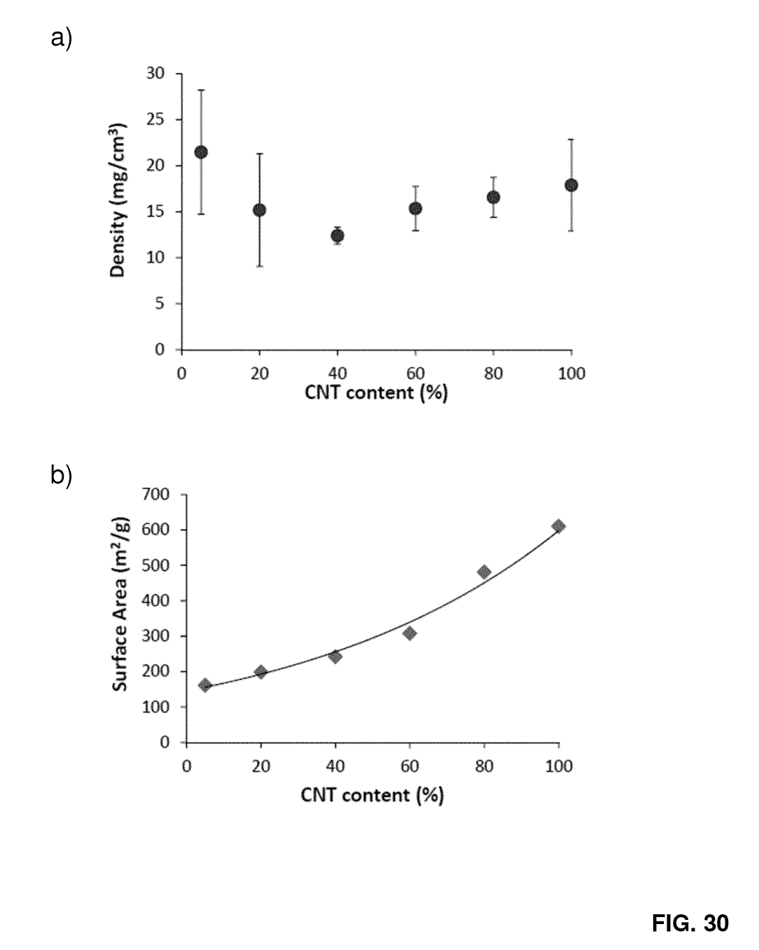

FIG. 30 provides data relating to various properties of hybrid CNT-graphene foams. FIG. 30A shows density changes depending on the different packing of CNTs and graphene flakes at different ratios. FIG. 30B shows that the surface areas of the foams increase with increasing concentrations of CNT.

### Example 4

### Carbon Nanotube Based Foams with Manipulated Morphology

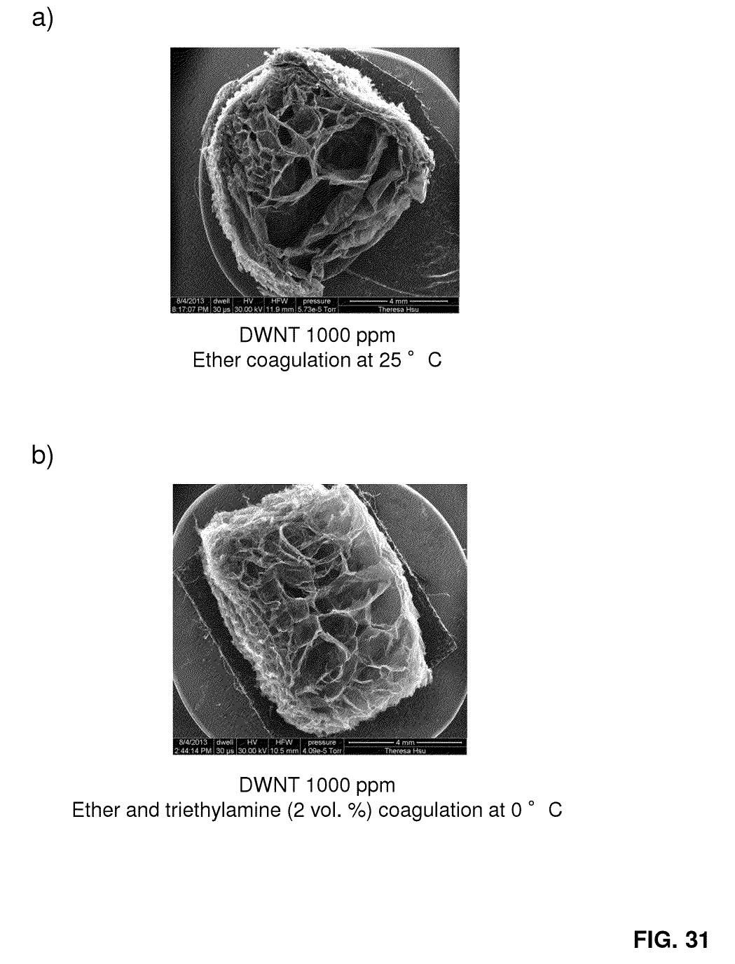

This Example demonstrates that the morphology of carbon nanotube foams can be manipulated by incorporating additives into a superacid solution and changing the coagulation bath temperature. FIG. 31 shows the morphology change of double-walled carbon nanotube foams when triethylamine (2 volume %) was incorporated into an ether coagulation bath and the coagulation temperature was reduced from 25° C. to 0° C. An image of a formed double-walled carbon nanotube foam treated in an ether coagulation bath at 25° C. is shown in FIG. 31A. An image of a formed double-walled carbon nanotube foam treated in an ether and triethylamine (2 volume %) coagulation bath at 0° C. is shown in FIG. 31B.

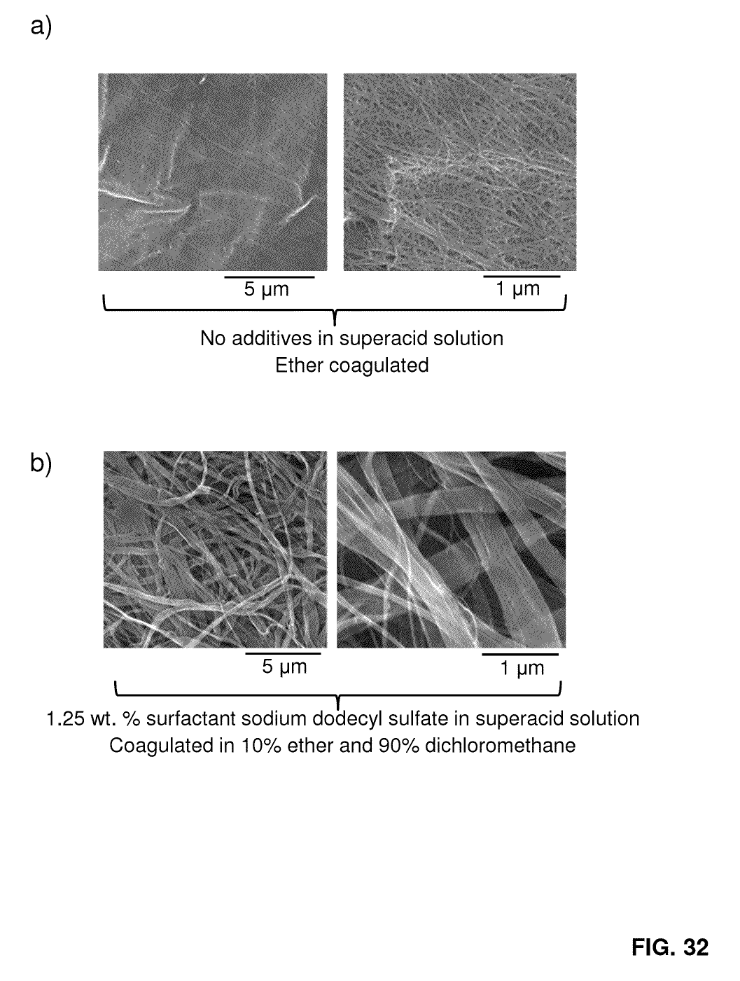

FIG. 32 shows a morphology change in double-walled carbon nanotube foams when 1.25% of surfactant sodium dodecyl sulfate (SDS) is incorporated into a superacid solution and the double-walled carbon nanotubes in the superacid solution are coagulated using a coagulation bath of 10% ether and 90% chloroform. An image of a formed double-walled carbon nanotube foam that was coagulated in ether in the absence of additives is shown in FIG. 32A. An image of a formed double-walled carbon nanotube foam that was coagulated in an ether and dichloromethane bath in the presence of 1.25% SDS is shown in FIG. 32B.

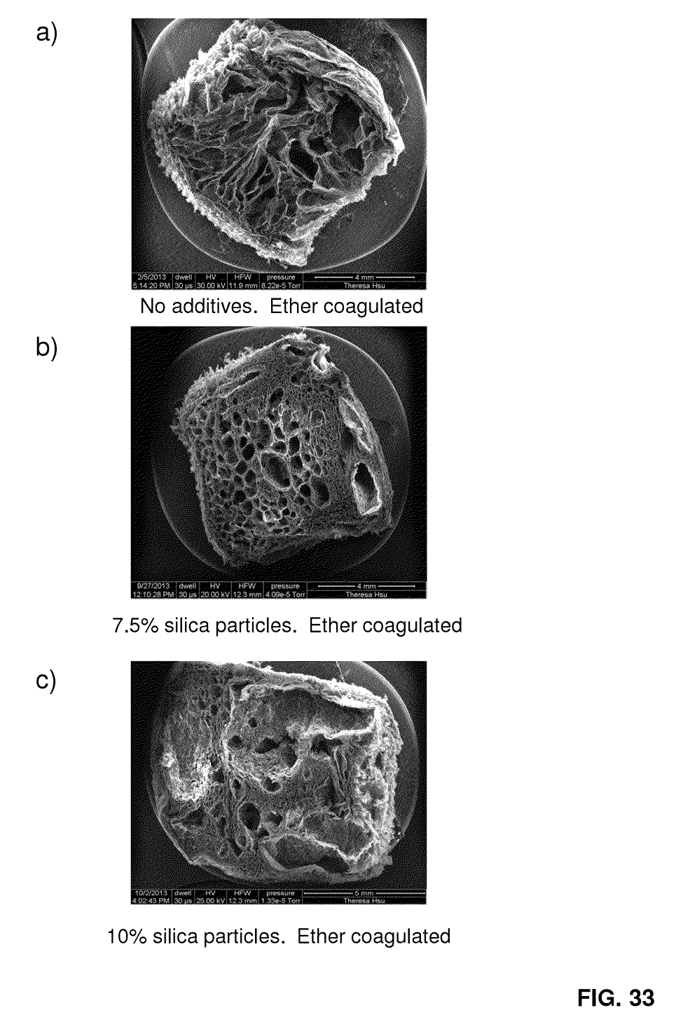

FIG. 33 shows a morphology change in double-walled carbon nanotube foams when silica particles are incorporated into a superacid solution and coagulated using a coagulation bath of ether at room temperature. An image of a formed double-walled carbon nanotube foam that was coagulated in ether in the absence of additives is shown in FIG. 33A. Images of formed double-walled carbon nanotube foams that were coagulated in ether in the presence of 7.5% and 10% silica particles are shown in FIGS. 33B and 33C, respectively.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making carbon foams, wherein the method comprises:
(a) Dissolving a carbon source in a superacid to form a solution;
(b) Placing the solution in a mold; and
(c) Coagulating the carbon source in the mold.

2. The method of claim 1, further comprising a step of washing the coagulated carbon source.

3. The method of claim 1, further comprising a step of lyophilizing the coagulated carbon source.

4. The method of claim 1, further comprising a step of drying the coagulated carbon source.

5. The method of claim 1, wherein the carbon source is selected from the group consisting of graphenes, fullerenes, fluorenes, carbon nanotubes, and combinations thereof.

6. The method of claim 1, wherein the carbon source comprises carbon nanotubes.

7. The method of claim 6, wherein the carbon nanotubes are selected from the group consisting of single-wall carbon nanotubes, short single-wall carbon nanotubes, ultra-short single-wall carbon nanotubes, double-wall carbon nanotubes, multi-wall carbon nanotubes, pristine carbon nanotubes, un-functionalized carbon nanotubes and combinations thereof.

8. The method of claim 1, wherein the superacid is selected from the group consisting of perchloric acid, chlorosulfonic acid, fluorosulfonic acid, trifluoromethane sulfonic acid, methane sulfonic acid, perfluoroalkane sulfonic acids, fluorosulfonic acid, triflic acid, antimony pentafluoride, arsenic pentafluoride, oleums, polyphosphoric acid-oleum mixtures, tetra(hydrogen sulfate)boric acid-sulfuric acid, fluorosulfuric acid-antimony pentafluoride, fluorosulfuric acid-SO₃, fluorosulfuric acid-arsenic pentafluoride, fluorosulfonic acid-hydrogen fluoride-antimony pentafluoride, fluorosulfonic acid-antimony pentafluoride-sulfur trioxide, fluoroantimonic acid, tetrafluoroboric acid, and combinations thereof.

9. The method of claim 1, wherein the superacid comprises chlorosulfonic acid.

10. The method of claim 1, wherein the solution further comprises an additive.

11. The method of claim 10, wherein the additive is selected from the group consisting of surfactants, silica particles, polymer particles, metal particles, organic solvents, amine-based solvents, fluorinated organic solvents, hydrophobic organic solvents, and combinations thereof.

12. The method of claim 1, wherein the coagulating occurs by exposing the solution to a solvent.

13. The method of claim 12, wherein the solvent is selected from the group consisting of ether, isopropanol, water, acetone, dichloromethane, chloroform, tetrahydrofuran, triethylamine, and combinations thereof.

14. The method of claim 1, wherein the coagulating comprises exposing the solution to ether.

15. The method of claim 1, wherein the method occurs without the use of surfactants or organic binders.

16. The method of claim 1, wherein the method occurs without the use of sonication.

17. The method of claim 1, wherein the method occurs without the use of chemical vapor deposition.

18. The method of claim 1, further comprising a step of infiltrating the formed carbon foams with nanoparticles.

19. The method of claim 18, wherein the nanoparticles comprise magnetic nanoparticles.

20. The method of claim 19, wherein the magnetic nanoparticles are selected from the group consisting of iron nanoparticles, nickel nanoparticles, cobalt nanoparticles, and combinations thereof.

21. The method of claim 1, further comprising a step of infiltrating the formed carbon foams with polymers.

22. The method of claim 21, wherein the polymers are selected from the group consisting of polydimethylsiloxane (PDMS), polyvinyl alcohol (PVA), polyethylene glycol (PEG), cross-linked polymer hydrogels, poly (epoxides), and combinations thereof.

23. The method of claim 21, wherein the infiltrating comprises:
(a) embedding the formed carbon foams with polymer precursors; and
(b) polymerizing the polymer precursors.

24. The method of claim 1, wherein the formed carbon foams comprise continuous networks of isotropic carbon nanotubes.

25. The method of claim 1, wherein the formed carbon foams have surface areas between about 400 m²/g to about 900 m²/g.

26. The method of claim 1, wherein the formed carbon foams have electrical conductivities greater than about 10 S/cm.

27. The method of claim 1, wherein the formed carbon foams have electrical conductivities of about ˜1900 S/cm.

28. The method of claim 1, wherein the formed carbon foams have a Young's modulus between about 1 MPA to about 10,000 MPA at 60% strain.

29. Wherein the formed carbon foams have a Young's modulus between about 4,000 MPA at 60% strain.

30. A freestanding carbon foam comprising:
a carbon source, wherein the carbon source comprises a continuous and three-dimensional network,
wherein the carbon foam has a surface area between about 150 m²/g to about 1000 m²/g,
wherein the carbon foam has an electrical conductivity greater than about 10 S/cm,
wherein the carbon foam has a density between about 4.5 mg/cm³ to about 70 mg/cm³, and
wherein the carbon foam has a Young's modulus between about 1 MPA to about 10,000 MPA at 60% strain.

31. The carbon foam of claim 30, wherein the carbon source is selected from the group consisting of graphenes, fullerenes, fluorenes, carbon nanotubes, and combinations thereof.

32. The carbon foam of claim 30, wherein the carbon source comprises carbon nanotubes.

33. The carbon foam of claim 32, wherein the carbon nanotubes are selected from the group consisting of single-wall carbon nanotubes, short single-wall carbon nanotubes, ultra-short single-wall carbon nanotubes, double-wall carbon nanotubes, multi-wall carbon nanotubes, pristine carbon nanotubes, un-functionalized carbon nanotubes and combinations thereof.

34. The carbon foam of claim 30, wherein the carbon source comprises continuous networks of isotropic carbon nanotubes.

35. The carbon foam of claim 30, wherein the carbon source consists essentially of carbon nanotubes.

36. The carbon foam of claim 30, further comprising infiltrated nanoparticles.

37. The carbon foam of claim 36, wherein the nanoparticles comprise magnetic nanoparticles selected from the group consisting of iron nanoparticles, nickel nanoparticles, cobalt nanoparticles, and combinations thereof.

38. The carbon foam of claim 30, further comprising infiltrated polymers.

39. The carbon foam of claim 38, wherein the polymers are selected from the group consisting of polydimethylsiloxane (PDMS), polyvinyl alcohol (PVA), polyethylene glycol (PEG), cross-linked polymer hydrogels, poly (epoxides), and combinations thereof.

40. The carbon foam of claim 30, further comprising an additive.

41. The carbon foam of claim 40, wherein the additive is selected from the group consisting of surfactants, silica particles, polymer particles, metal particles, organic solvents, amine-based solvents, fluorinated organic solvents, hydrophobic organic solvents, and combinations thereof.

42. The carbon foam of claim 30, wherein the carbon foam has an electrical conductivity of about ˜1900 S/cm.

43. The carbon foam of claim 30, wherein the carbon foam has a Young's modulus of about 4,000 MPA at 60% strain.

44. The carbon foam of claim 30, wherein the carbon foam has a density of about 5 mg/cm³.

45. The carbon foam of claim 30, wherein the carbon foam has a porosity greater than about 95%.

46. The carbon foam of claim 30, wherein the carbon foam has a porosity greater than about 99%.

47. The carbon foam of claim 30, wherein the carbon foam has a surface area between about 400 m²/g to about 900 m²/g.

48. The carbon foam of claim 30, wherein the carbon foam is hydrophobic.
